(19) United States
(12) Patent Application Publication
(10) Pub. No.: US 2005/0069371 A1
(43) Pub. Date: Mar. 31, 2005

(54) Normally handheld instruments allowing normal fingertip activity

(76) Inventors: Joseph L. Lutgen, Centennial, CO (US); Ralph E. Lagergren, Alma, KS (US); John E. O'Mara, Wichita, KS (US); Eric S. Zeitlin, Baldwin, NY (US); Jason R. Richards, West Bend, WI (US)

Correspondence Address: Roper & Quigg;Suite 1000, 200 South Michigan Avenue, Chicago, IL, 60604, US

(21) Appl. No.: 10/672,602

(22) Filed: Sep. 26, 2003

(51) Int. Cl. A46B 11/00; B43K 25/00

(52) U.S. Cl. 401/48; 24/10 R

(57) ABSTRACT

A normally handheld instrument adapted to be removably affixed to the hand of a user is provided. The instrument includes an instrument body, a utensil such as a writing utensil within the body and a retainer attached to the instrument body. The retainer allows the instrument to be removably affixed to a part of the user's hand. When so affixed, the instrument is positionable in at least two positions: a first resting position in which the user's fingertips are available for normal fingertip activities and a second normal use position for normal use of the instrument and its utensil.

### TECHNICAL FIELD

The present invention relates to improvements for normally handheld instruments, for example, writing instruments. As referred to herein, such instruments contain one or more utensils or tools. A writing instrument, for example, would contain a writing utensil such as a pen, a pencil, a PDA stylus, a digitizer stylus, a crayon or a highlighter. Other instruments would contain other utensils or tools such as, for example, a scribe, a laser pointer, a medical device such as a scalpel or other instrument, a mouse pointer or a wireless pointer or controller.

Disclosure Document No. 511444, entitled Safety Finger Pen, submitted May 7, 2002, and received May 13, 2002: Disclosure Document No. 514227, entitled Finger Instrument Attachment Device, submitted Jun. 19, 2002, and received Jun. 25, 2002; Disclosure Document No. 527588, entitled Zwriter or Zip Pen Additional Claims, submitted Mar. 7, 2003, and received Mar. 12, 2003; and Disclosure Document No. 533625, entitled Short Hand Attached Writing Instruments Which Mimic Natural Writing Position, submitted Jun. 20, 2003, and received Jun. 24, 2003, each disclose various embodiments of instruments of the invention.

Specifically, the present invention relates to an improvement in such instruments in which the instrument is adapted to be removably affixed to the hand of a user. The improved instruments are attached to the user's hand in a manner that provides for two separate and distinct positions for the instrument without removing the instrument from the user's hand. The first position is referred to as the resting position and, when the instrument is in the resting position, all of the user's fingers are available for normal fingertip activities such as operation of a computer keyboard, a computer mouse, a telephone keypad, reading a book, and other activities. The second position is referred to as the normal use position and, when the instrument is in the normal use position, the instrument is capable of being used in the normal and usual way.

While many differing users may have differing positions of use, the instruments of the present invention are capable of being used in the normal use position as hereinafter defined whether or not any actual user uses the device in that position or in another position that is more comfortable and ordinary for that user.

Further, the instrument included of this invention could be used by handicapped persons or those with severe hand mobility issues who can not easily hold instruments in natural positions. These instruments may also help prevent Repetitive Stress Injuries and Carpal Tunnel Syndrome. These instruments can also be used to teach the natural or correct writing position for those learning the proper writing position and posture.

The transition from the first to second position may be accomplished in two distinct ways. Instruments that employ the first such method will be referred to as dynamic instruments and in such instruments, the position change includes some movement of the instrument body relative to the hand and relative to the retainer attaching the instrument body to the hand, such as for example sliding, pivoting or rotating of the instrument body from the first position to the second position. Such dynamic instruments may have the movement from rest to use position and back again to rest position occur by simply having the user exert a force on the instrument body, for example by use of fingers or by a flicking motion of the wrist, or the movement may be provided by a spring or other force-inducing device connected to the instrument body itself and typically activated by a button or lever.

A static instrument employs a second method. A static instrument involves substantially no movement of the instrument body relative to the retainer when transitioning from rest to use position and back again to rest position. Rather, the transition from position to position occurs primarily merely by movement of the user's fingers and not by movement of the instrument itself. In such embodiments, the instrument body is not gripped in the rest position but rather is held in position by the retainer out of the way of the fingertips. Once gripped, the instrument body is considered to be in the normal use position and is ready for such use.

The retainer may be rotatable on the user's hand to bring it from the rest position to the normal use position or to adapt the position from the normal use position to a personal use position. This can be done by designing the retainer so as to allow the instrument to rotate around the user's hand easily. It is understood that this can be done in two ways. First, the retainer could be attached to the user's finger and the attachment means for attaching the retainer to the instrument body could be a separate piece, or even another member could be provided, and allowed to rotate thereby moving the instrument body, similar to the way in which a bearing works. Second, it is also understood that, if the retainer is provided with a slick surface, the retainer itself could rotate on the surface of the user's hand thereby moving the instrument body. For example, the instrument body would be rotated above the finger when in not in use and then back down into the normal use position.

Either dynamic or static instruments may incorporate a mechanism which moves the utensil relative to the instrument body or have a cap that slides relative to the instrument body to cover the tip when not in use. These mechanisms that extend the refill or extend or retract a cover are typically activated by a push button or a slide but are not limited to these methods. They may also be activated with a flick of the wrist or other force-inducing motion.

### BACKGROUND OF THE INVENTION

There are a number of normally handheld instruments such as writing instruments, pointers, styluses, etc. Over the years, various devices have been developed to attempt to hold such devices, especially writing instruments, in a particular relationship to a user's hands. This includes, for example, finger-mounted writing instruments or writing instrument holders. Many of these devices have been developed to ease use of the devices or to provide ready access to the devices or for other reasons.

All of these prior art suggestions known to the applicants have had varying degrees of success; however all suffer from various drawbacks including uncomfortable fit and the inability to allow a user to employ the device so that, without removing the device, the user can employ the device in two positions, one of which allows the fingertips of the user to perform normal fingertip activities while the instrument is affixed to the user's hand and the other of which allows the user to employ the instrument in the normal and usual fashion.

None of the known prior art devices has adequately addressed this issue.

### DISCLOSURE OF THE INVENTION

The present invention relates to any type of instruments, preferably normally handheld instrument and more preferably writing instruments. Wherever the terminology writing instrument is employed herein it will be understood by one of skill in the art that other instruments can be substituted.

The instrument of the present invention comprises an instrument body having any shape, but preferably shaped similarly to any of the shapes used for the normally handheld instruments such as writing instruments and more preferably having a generally cylindrical shape or an organic/ergonomic shape. A utensil, such as a writing element, stylus, etc. is located within the instrument body.

The instrument body of the instrument of this invention is removably affixed to any part of the user's hand by use of what will be referred to herein as a retainer. Preferably, the attachment is to a finger. More preferably, the instruments of the present invention are affixed to the middle phalange of the thumb, the middle phalange of the index or middle finger, or the proximal phalange of the index or middle finger. In one preferred embodiment, the attachment is to the middle phalange of the middle finger.

The retainer is attached to the instrument body. In one embodiment an attachment adapter is used to attach the retainer to the instrument body. The attachment adapter and the retainer may be separate pieces or may together be a unitary piece that acts as both the retainer and the attachment adapter. Another embodiment is that the retainer, attachment adapter, and instrument body are all one unitary piece. This would save substantial costs in manufacture and assembly costs.

However attachment of the retainer to the instrument body is accomplished, the retainer and/or the means of attaching the retainer to the instrument body are resiliently adjustable and shapeable (preferably the retainer has these attributes) in such a way so that, when worn by the user and in the first resting position, the instrument body is positioned in a way that allows the user's fingertips to be available for more fingertip activities and can also be placed in a second position, the normal use position.

### BRIEF DESCRIPTION OF DRAWINGS

FIGS. 1A and 1B are isometric views of a hand holding an instrument and showing the degree of variation in the “normal use position.”

FIG. 2 is an isometric view of a static writing instrument constructed in accordance with this invention.

FIG. 3 is an exploded view of the writing instrument of FIG. 2.

FIG. 4 is a close-up view of the retainer and attachment means of the writing instrument of FIG. 2.

FIG. 5 is a top view of the writing instrument of FIG. 2.

FIG. 6 is an isometric side view of the writing instrument of FIG. 2 with the retainer being slid onto the body.

FIG. 7 is a top view of the writing instrument of FIG. 2 showing the adjustability of the angle of the body to the band.

FIGS. 8A and 8B are views of static writing instrument showing possible positions for button locations for an embodiment of the writing instrument of FIG. 2 that has a retractable utensil.

FIG. 9 is a top view of a hand with the static writing instrument of FIG. 2 affixed to the middle phalange of the middle finger and in the rest position.

FIGS. 10 and 11 are differing actual use or rest position views of the static writing instrument of FIG. 2.

FIGS. 12 and 13 are top and bottom views of an embodiment of a dynamic writing instrument constructed in accordance with this invention which has the instrument body across the palm of the hand when in the rest position..

FIGS. 14 and 15 are views of another dynamic writing instrument constructed in accordance with this invention which has the instrument body across the palm of the hand when in the rest position.

FIGS. 16A and 16B are views of a dynamic embodiment with the instrument placed above the hand in the rest position.

FIGS. 17-20 show a dynamic embodiment in which the instrument is attached to the middle finger.

FIGS. 21 and 22 depict a dynamic side storage instrument.

FIGS. 23-25 depict a dynamic underneath storage instrument adapted for the middle finger.

FIGS. 26-28 depict a dynamic embodiment that provides for a spin motion of the instrument body.

FIGS. 29-32 depict various dynamic slide instruments which attach to the index finger.

FIGS. 33-42 depict dynamic “switchblade” type embodiments.

FIGS. 43-44 depict a dynamic embodiment for the middle phalange of the middle finger.

FIGS. 45-46 show additional static embodiments particularly adapted for the thumb.

FIGS. 47-48 depict a dynamic embodiment adapted for the thumb.

FIGS. 49-50 depict a dynamic hinged embodiment.

FIGS. 51-52 depicts another pivoting embodiment that rests on the top of the hand

### MODES FOR CARRYING OUT THE INVENTION

### DETAILED DESCRIPTION OF THE INVENTION

As used herein, “hand” refers to the hand or any part of the hand such as the palm, the fingers, or any other part of the hand.

“Finger” refers to any of the fingers including the thumb and to any location on any of the fingers.

“Short” used in connection with the instrument body refers to an instrument body that is about 4 inches or shorter. Typical full-length writing instruments are normally at least about 5 ½ inches in length. The instrument body of the present invention can be made in various sizes, or could be made adjustable, i.e., telescoping or extending, to accommodate various size hands. The use of a short instrument body in the present invention, rather than a full-length instrument body, is preferred because it greatly aids in allowing the user's fingertips to be fully available for use when the instrument is in the rest position. Use of a full length instrument can be inconvenient because the large instrument can dangle from the hand and can get in the way of normal fingertip activities even when in the first resting position. Preferably, the instrument body is shorter than 4 inches. In certain embodiments, the instrument body is preferably shorter than 3½ inches, with some embodiments having instrument bodies that are about 2 inches or less.

“Resting position” or “rest position” refer to a first position for the instrument body. Specifically, the terms refer to a position in which the user's fingers are available for normal fingertip activities and the instrument body generally does not interfere with those normal fingertip activities.

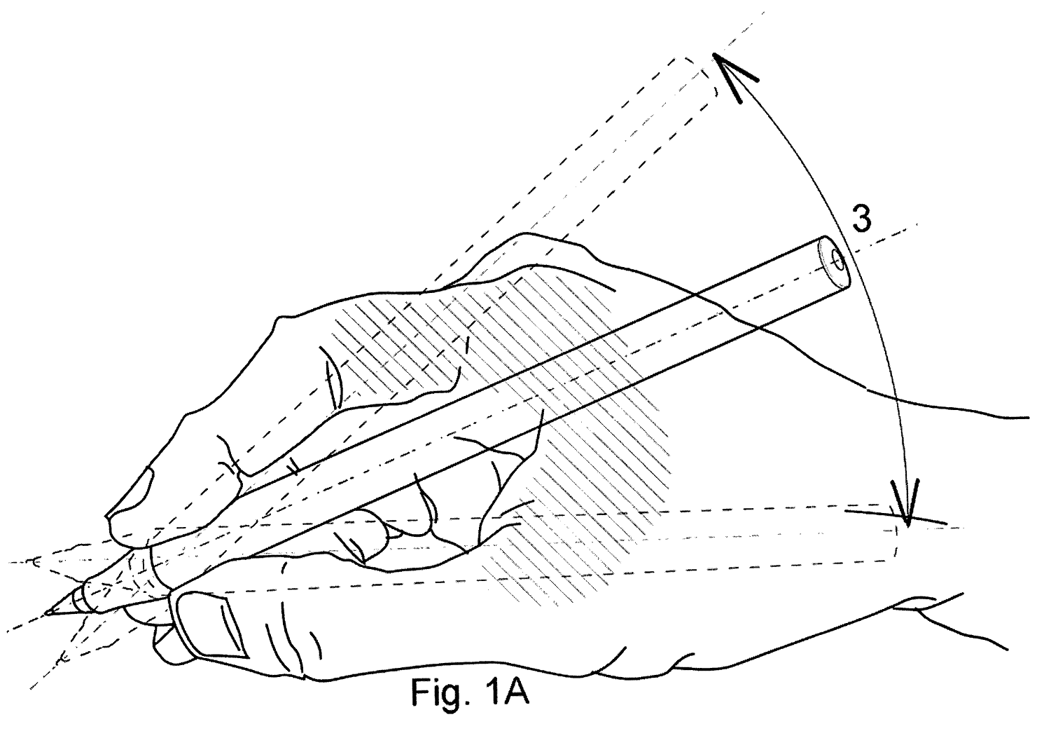

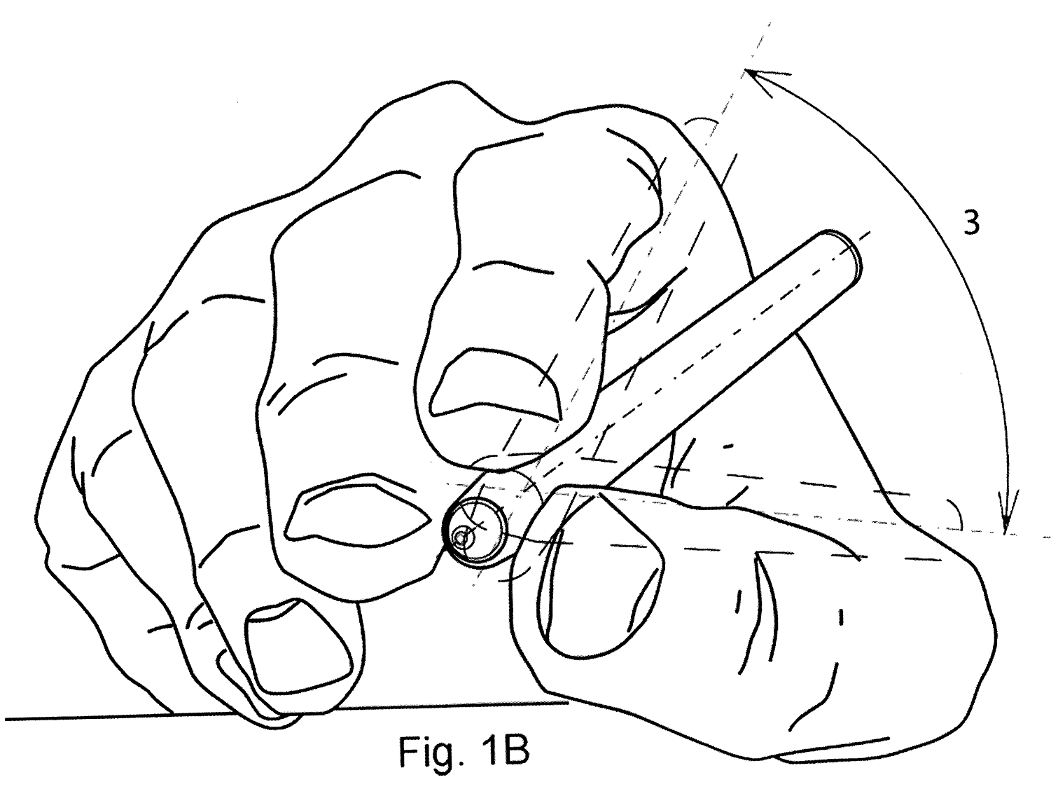

“Normal use position” (alternatively and interchangeably referred to as the “natural writing position”) refers to a second position for the instrument body. These terms do not necessarily refer to the actual or personal use position that any particular individual uses to write or otherwise use the handheld instruments. Rather, they refer to an idealized position. As can be seen by reference to FIGS. 1A and 1B, the normal use position is defined as a grip using three fingers, the thumb, the index finger, and the middle finger, to hold the instrument with the rear end extending back toward the wrist or the skin between the index finger and thumb, this is known as the “4^{th} grip point”. The angle 3 shown in FIGS. 1A and 1B show that the normal use position is a range of positions with angle 3 being approximately 120 degrees. The angle 3 is measured using the angle vertex that is defined as the point where each finger first touches the body of the instrument to form a “tripod” grip. These three points define a plane. This plane intersects the central axis of the instrument body to form the vertex of the angle 3. The two “legs” of angle 3 are the line between the vertex and the rear end of the instrument body and a line parallel to the thumb central axis and through the vertex. This position is what is intended throughout this disclosure when the terms “normal use position” or “natural writing position” are used. It is recognized that not every user of the hand held instruments of this invention, especially writing instruments, will use a grip of this type but, the normal use position is set forth as one of the positions into which the instruments of this invention can go. Thus, it is recognized that, for some persons based upon their normal grip, certain embodiments of the instrument of this invention would not allow them to write in their own personal normal use position and would thus may not be especially useful for such persons.

“Utensil” includes “writing utensil” and refers to the actual part used in the instrument (as contrasted with the body that holds the utensil) and is inclusive as possible including, but not restricted to a pen, a pencil, a PDA stylus, a digitizer stylus, a crayon or a highlighter. Other instruments would contain other utensils or tools such as, for example, a scribe, a laser pointer, a medical device such as a scalpel or other instrument, a mouse pointer or a wireless pointer or controller. Such utensils can be contained within the body, for example a pen insert, a cavity in the instrument body can be part of the utensil, for example by being an ink reservoir, or the utensil may be integral with the body, for example a PDA stylus whose tip is a unitary part of the body.

“Retainer” refers to the means for removably affixing the instrument to the hand. In one embodiment, the retainer is a resiliently adjustable and shapeable piece designed to fit a particular part of the hand, such as a finger. One such retainer takes the form of a flexible open ring. Such a ring can be made of metal, plastic or of wire for increased comfort and ventilation. Other forms for the retainer include but not limited to a spring loaded clip, a full ring made of material that can stretch easily to prevent cutting off circulation, a band made of wire or a handcuff-like mechanism to quickly snap connect the retainer to a finger.

There are five essentially differing embodiment “activation” modes in which the user can transition between the first position, the resting position, and the second position, the normal use position. The first is a static embodiment in which the retainer is designed so that the instrument body is positioned to leave the fingertips free for normal fingertip activity but can be grasped by the fingertips for use in a normal use position.

In a second embodiment, in which there is dynamic movement, the body is located during the resting position in a retracted position, and the user can then grasp the body, or operate means for movement of the body, to allow the body of the instrument to be moved into the normal use position with provisions being made for the instrument to retract back into a resting position. Such a device can be made by use of, for example, a spring, or other resilient movement device such as flexible material, for example, a thermoplastic elastomer or its equivalent as known in the art.

Alternatively, in a third embodiment of the present invention, a button or other device is activated by the user when the user wishes to move the pen from the first resting position into the second use position in which the instrument is provided in the normal use position. In this embodiment, the device may or may not be equipped to return to the first resting position automatically such as by a spring loaded device, or may require the user to exert a force to return the device to the first, resting position.

In the fourth embodiment of the present invention, the body can be manually pushed into any position by either hand or any finger to push the writing instrument from the first position to the second position.

In the fifth embodiment of the present invention, the body can be moved dynamically by a flick of the finger, wrist, or arm. This movement induces movement in the pen body to push the writing instrument through rotation out of the way of the user's finger tip activities.

In any of these activation modes, a protrusion or tab is optionally provided on the instrument body to facilitate the movement of the pen. While these are the preferred activation modes contemplated, one of skill in the art will readily perceive that other activation modes could also be used and those modes are likewise within the scope of the present invention.

In any of these embodiments, the utensil in the instrument—such as a pen refill—may be retractable or may be fixed.

In all embodiments, the instrument is preferably attached to the middle finger, index finger, or thumb, but the device can also be adapted such that the attachment occurs around several fingers or even the entire hand. In one of these embodiments, it is preferred that the instrument body in its resting position be located above the hand, when the hand is in the palm down position. Preferably when using the third “activation” embodiment, the instrument body is located beneath the palm of the hand and is out of the way underneath the palm of the hand in the rest position.

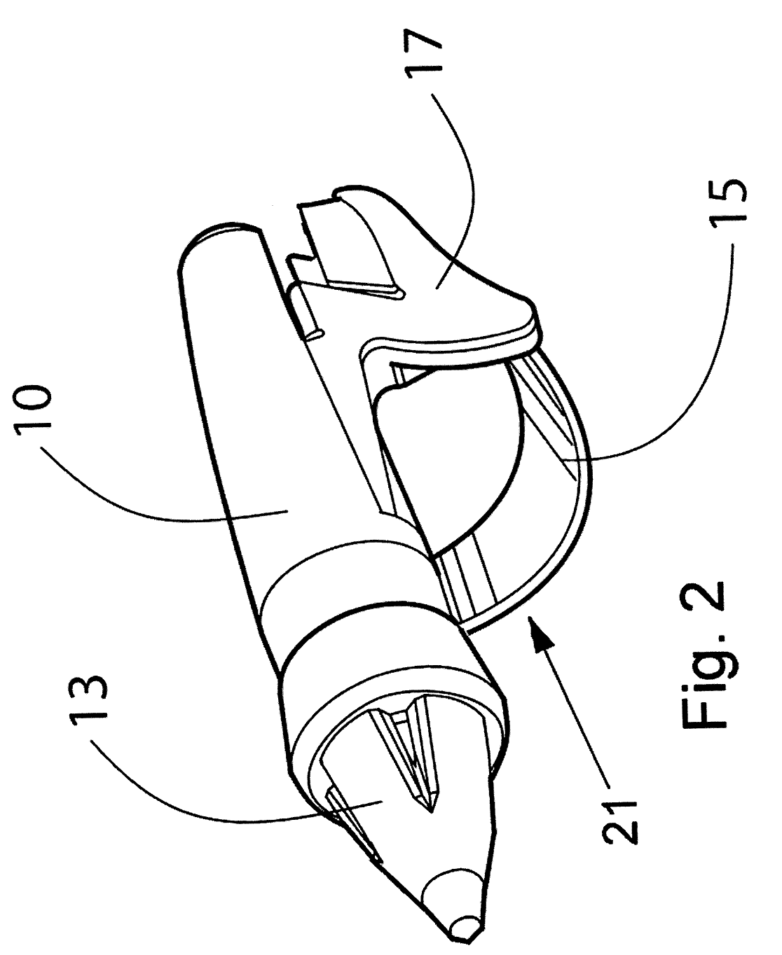

Referring now to FIG. 2, there is shown a perspective view of a static type pen within the scope of this invention. The instrument body 10 is seen along with cap 13 of the instrument. The use of a generally cylindrical shape or an ergonomic shape for the instrument body 10 is preferred as it accommodates many styles of normal use of the instrument, especially for a writing instrument. This may also include overmolded gripping areas (not depicted) to provide a soft location for fingertips to engage the instrument body 10. In a preferred embodiment, the instrument body 10 is made of a soft thermoplastic elastomer to ensure comfortable gripping areas.

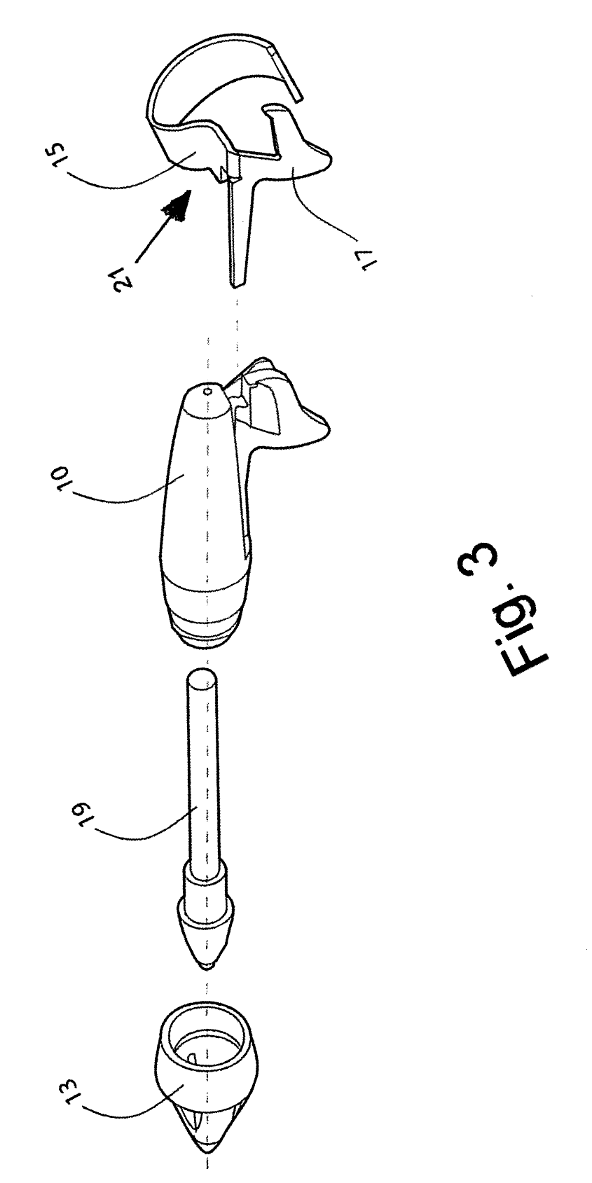

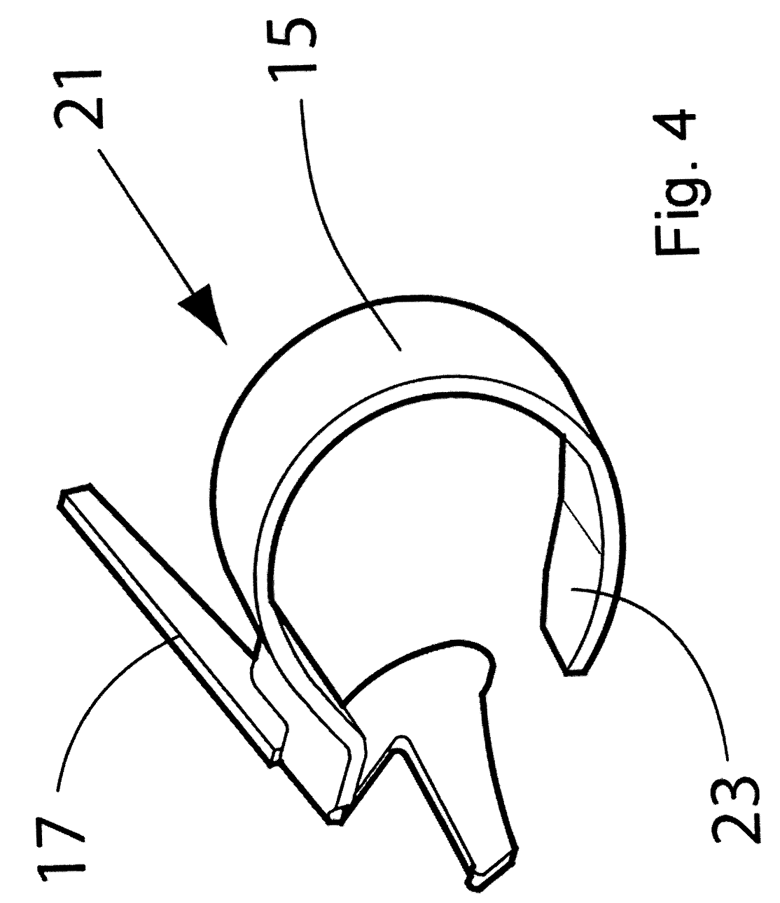

Also visible is the attachment means 17 for attaching the retainer 15 to the instrument body. In this embodiment, the attachment means 17 is part of a single piece 21 that includes retainer 15 and attachment means 17 for attaching retainer 15 to instrument body 10. More specifically, and as seen in FIGS. 2 and 3, in this embodiment, attachment means 17 is a Z-shaped adapter although the shape of the adapter can be varied for both aesthetic and use purposes as will be appreciated by those of skill in the art. FIG. 3 shows an exploded view of the parts of a writing instrument in accordance with an embodiment of this invention. Clearly seen is instrument body 10, including the cap 13, utensil 19, which in this embodiment is a pen that fits within the instrument body 10. Also shown is the single piece 21 that includes retainer 15 and attachment means 17. FIG. 4 provides additional detail of piece 21 that includes retainer 15 and attachment means 17.

The retainer 15 is a flexible, generally C-shaped, open ring that can be adjusted to the appropriate size for the comfort of the user. It is preferred to optimize for fingers of size in the 5^{th} percentile for woman, to the 95^{th} percentile man. This ring could also be sized appropriately for children and also adults for finger sizes outside this range. The open ring shape allows blood flow through at least a portion of the finger even if the user inadvertently adjusts the retainer too tight. The retainer also allows for a secure writing grip. A typical writing instrument employs the tripod grip plus the skin between the index and thumb (4^{th} grip point). This 4^{th} grip point is achieved by the retainer securely attached to the finger. This 4^{th} grip could be obtained by other means such as a band around the hand. The C-shaped finger retainer depicted in FIG. 4 also allows the user to move the piece 21 that includes retainer 15 and the attached instrument on the finger for more adjustability for comfort and ease of use.

Along its length, in some embodiments it is preferable for the retainer to be frustro-conical in shape to provide better fit on the user's fingers. Preferably the end of the band not attached to the instrument body is provided with a flat portion 23 which allows for extra comfort when the user's fingers are larger than normal; without such a flat, it is evident that the band would more naturally exert a force on the finger and yield the sensation that the end of the band is digging in to the finger. This same result can also be accomplished by making the band tip of a flexible material. Such an arrangement provides a similar advantage as the flat portion described above. Preferably the end corners of the band are rounded again for extra comfort and so as to avoid sharp corners or points.

The retainer can be made of any material that allows it to be resiliently adjusted and shaped such as plastic or appropriate metals. Preferably the retainer holds its shape after adjusting. In one preferred embodiment, the retainer is made from aluminum, more preferably aluminum that is powder coated, though other metals and other coatings—such as paint—can also be used. If a coating is used, important considerations in choosing the coating are that the coating be slick—or at least not sticky—so as to more easily allow the retainer to be comfortably affixed to a finger and slid onto the finger or other part of the hand with minimal effort. The retainer could also be rubber coated with an easily bendable band, so that the user can pull the retainer to open it. In this embodiment the band would have to be opened after use and fitted before use. The coating is also preferably made from a material that does not crack or chip when the retainer is adjusted and shaped. The coating can also prevent oxidation of the retainer material—if it is made from an oxidizable material such as aluminum—and also can round and soften the edges of the retainer for greater comfort. Other methods of coating such as annodization or plating with silver, gold, platinum or other precious metals is possible but the band edges are preferably rounded through a tumbling process to remove burrs and to increase the roundness of all edges of the retainer.

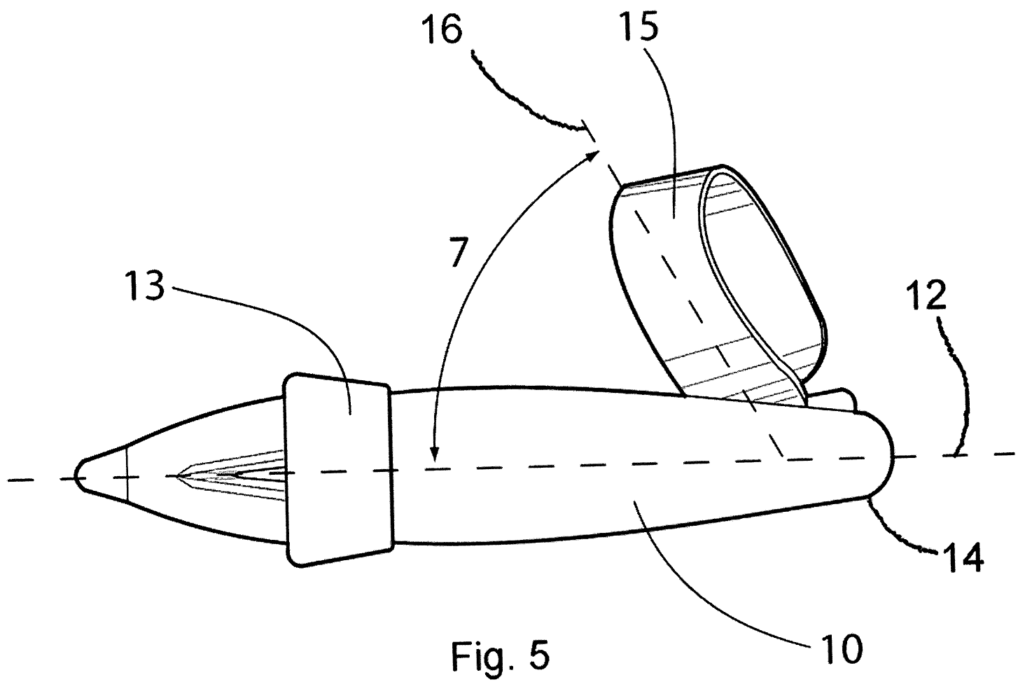

FIG. 5 depicts again the instrument body 10, cap 13, and retainer 15. FIG. 5 is a top view indicating the angle 7 between the center line of the retainer 15 and the center line of instrument body 10.

One important consideration in designing the retainer and the attachment of the retainer to the instrument body when a static embodiment is being designed is the angle 7 between the retainer and the instrument body. The retainer/body angle 7, defined as the angle between the centerline 12 of the instrument body 10 and the centerline 16 of the retainer 15 should be acute. Most preferably, this angle 7 is about 60 degrees so that the retainer 15 does not dig into the finger when the instrument is being used in its normal use position. Such an angle also allows the back end 14 of the instrument body 10 to move slightly allowing more freedom for a user to put the instrument in a comfortable use position. While other angles can be used, applicants have observed that obtuse angles often caused discomfort for the user.

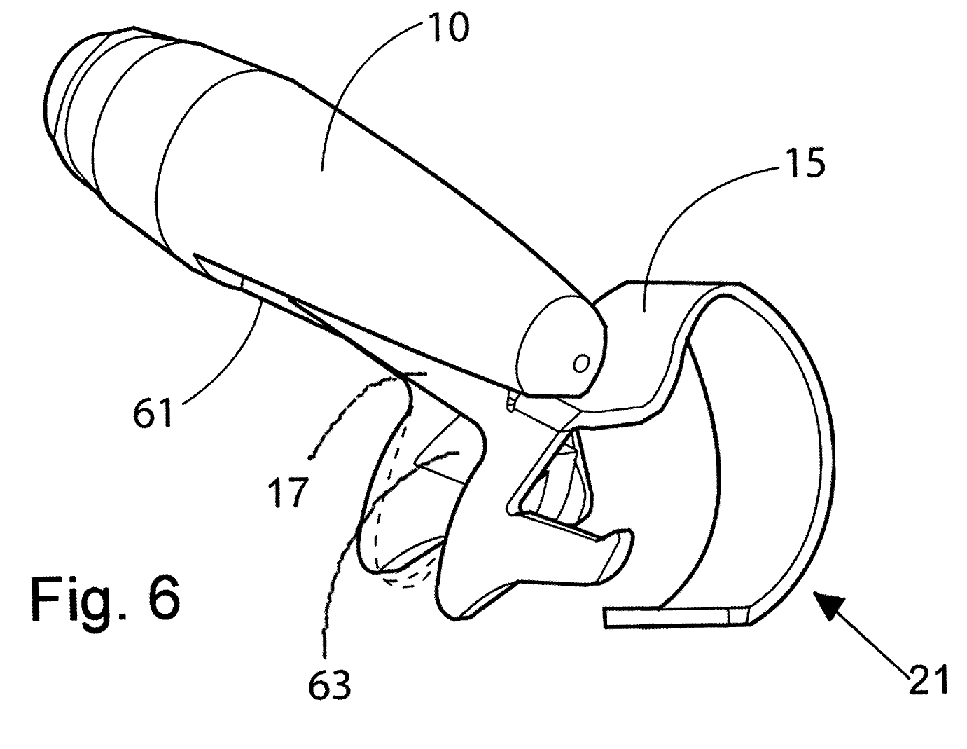

FIG. 6 shows a particular embodiment of the device of this invention wherein the retainer 15 is attached to the body 10 by means of an attachment adapter 17 that is part of a unitary piece 21 with the retainer. The attachment adapter 17 is inserted into slot 61 on body 10 and engages tab 63 that extends from body 10. Tab 63 can be made to have some flexibility so that there is a flexibility for assembly purposes. As depicted in FIG. 6 with dotted lines, tab 63 is flexible and is flexed as the attachment adapter 17 is slid onto body 10. Such flexibility eases assembly and allows for an additional benefit. It will be appreciated that, if such assembly is reversible and simple, the device could be sold in kits with differing bodies 10—for example in shape or color—and differing pieces 21—for example in color and appearance and shape—so that users could create unique final assemblies.

In preferred embodiments designed for finger attachment, part of the instrument body is provided with a concave surface in order to facilitate interfacing with the surrounding fingers. In a preferred embodiment, the portion of the instrument body that comes in contact with the finger(s) adjacent to where the retainer is affixed is shaped so that the surface has a slight concavity thus allowing the adjacent finger(s) to more comfortably nestle against the instrument body. These contoured surfaces could also be adapted to be part of the retainer.

It is contemplated that the manufacture of the instrument body itself may have many different constructions depending upon the desired results. All of these modifications are within the scope of the skill of one of ordinary skill in the art of making such instruments and are not unique to the instruments, including writing instruments, of the present invention.

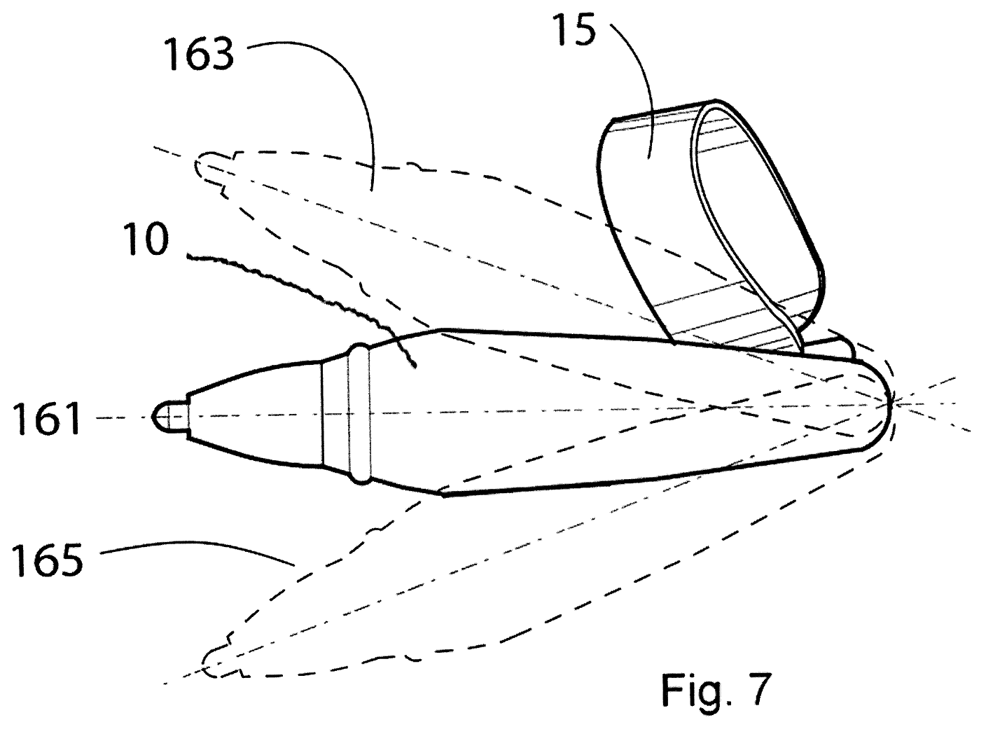

FIG. 7 shows an instrument of the invention including instrument body 10 and retainer 15. If there is flexibility in retainer 15, or flexibility of the attachment means 17 between the retainer 15 and the instrument body 10, the body 10 can be moved from the position shown as 161 to the positions shown in dotted lines, position 163 and position 165, to accommodate different writing styles of particular users. This adaptability is possible because of the resilient nature of the retainer 15 and its attachment to the body 10 that such deflection of the body relative to the retainer is possible.

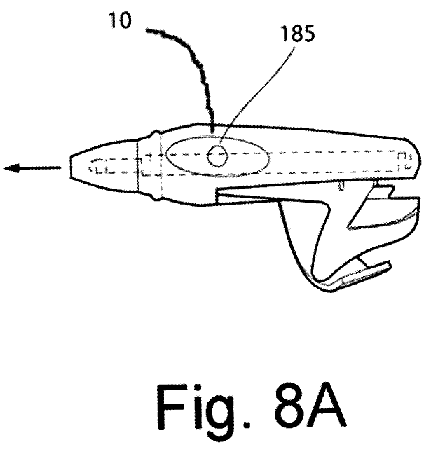

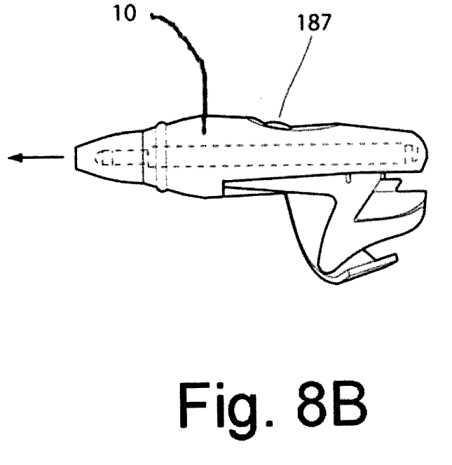

FIGS. 8A and 8B depict two different embodiments for an optional push button that could be located on the instrument body. Such a button, when activated, extends the utensil located within the body, such as the pen refill out of the instrument of the body and retracts when not engaged. Thus, FIGS. 8A and 8B show an instrument body 10 with two alternative push button arrangements showing push button 185 on the side of body 10 or push button 187 on the top of body 10. It is to be noted that these are entirely optional features both of the present embodiment and of all of the embodiments of this invention. These locations are optimized for use with either the thumb or index finger for this embodiment.

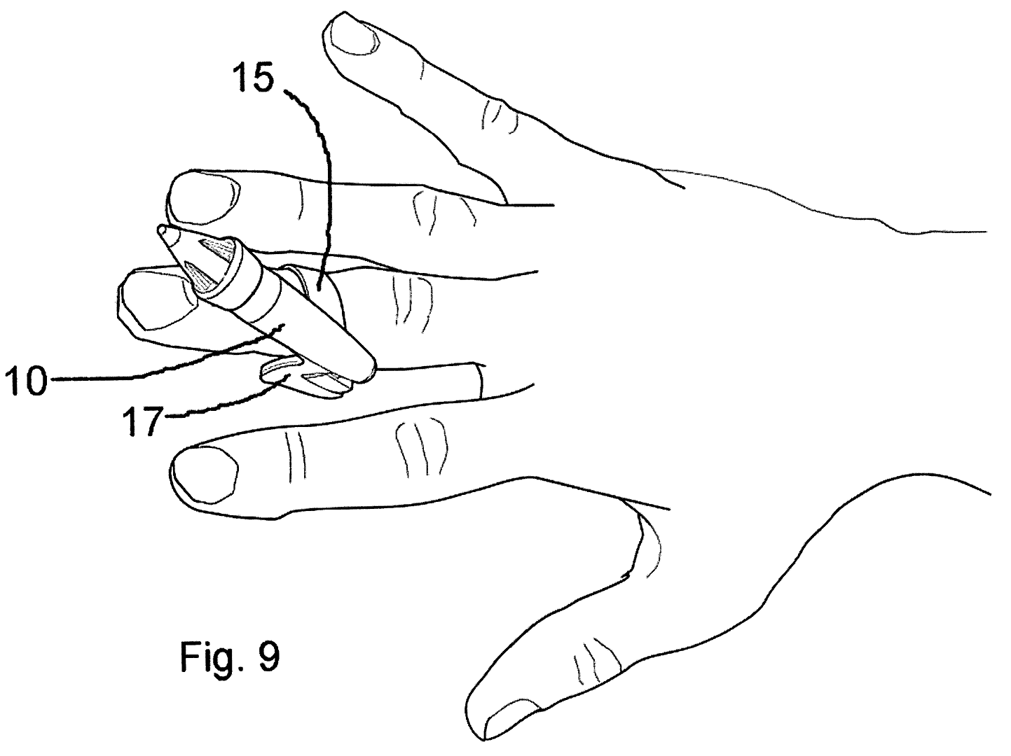

Now by reference to FIG. 9 there is shown a top view of a hand with the instrument affixed to the middle phalange of the middle finger. As shown the body 10 is in the first resting position and, as can be seen, all of the fingertips of the hand on which the instrument is located are available for normal fingertip activities.

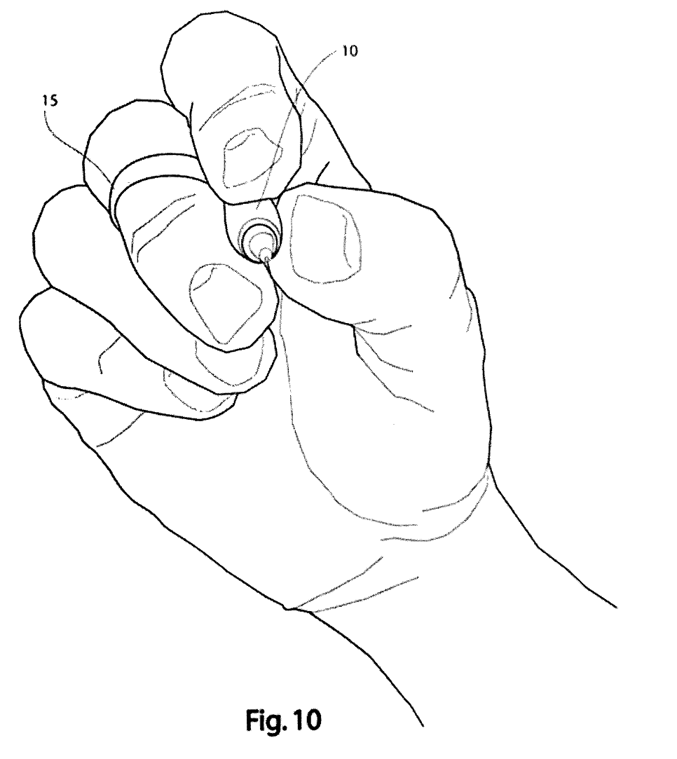

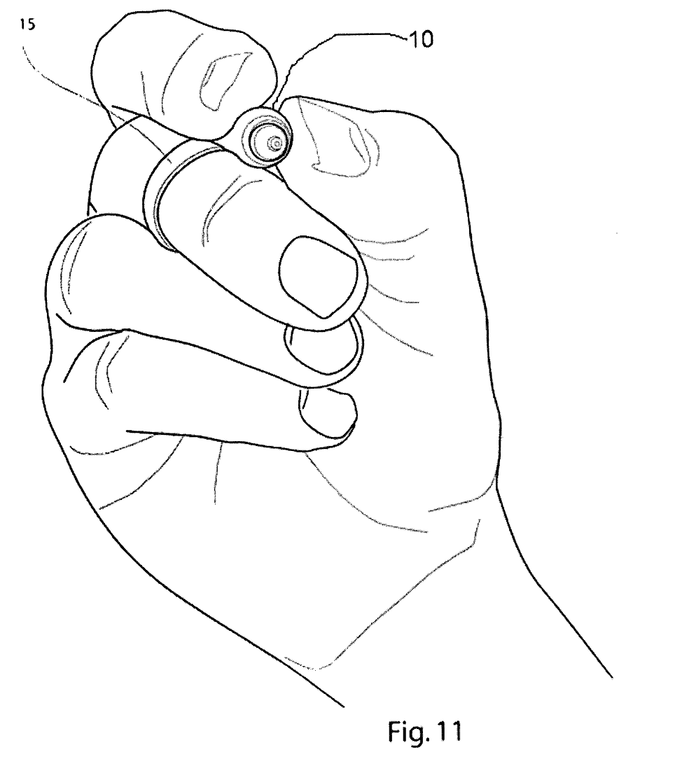

FIGS. 10 and 11 show two different potential actual use positions for the device. FIG. 10 shows a front view of a hand holding the instrument body 10 where the instrument body 10 has been rotated from the typical rest position, and FIG. 11 shows a front view where the instrument body 10 has been rotated in a different manner. As can be seen from these figures, it is possible for many users to employ the device in a way that allows them to use the device, such as the writing instrument depicted here, in their own personal use position. A user could use either position as their personal use position and may rotate the retainer 15 on the finger to push the pen further out of the way of finger tip activities. In this way, this pen can move relative to the hand but is not considered a dynamic device because it is intended to be positioned on the hand to have the first and second positions at the same location, thus there is no need to rotate the pen into position.

For any of the embodiments discussed herein, the retainer is optionally provided with cutouts or other perforations. Any such cutout may be used throughout the retainer so long as the retainer continues to have adequate strength to perform the retainer function. The use of such cutouts or punches on the retainer can create a more visually interesting appearance to the retainer band, can add flexibility to allow it to be more adjustable and shapeable and can also allow for additional airflow to the user's fingers so that, especially in extended wear circumstances, the comfort level of the user is enhanced. This is especially so if the user is of the type that, while continuing to have the instrument affixed to the hand by the retainer, rotates the retainer in order to allow different portions of the skin touching the retainer to receive air.

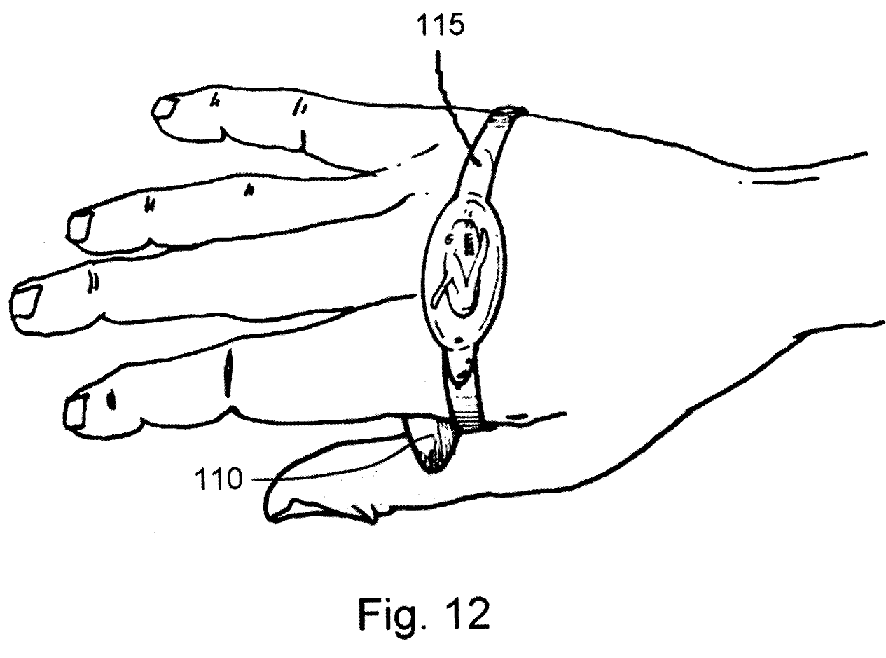

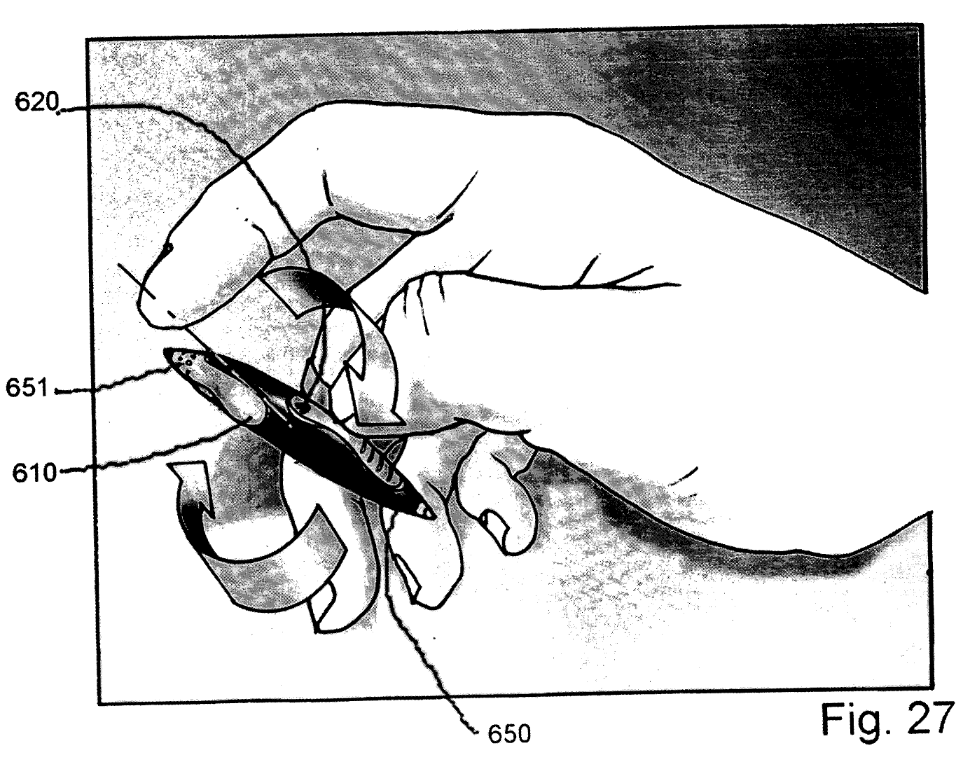

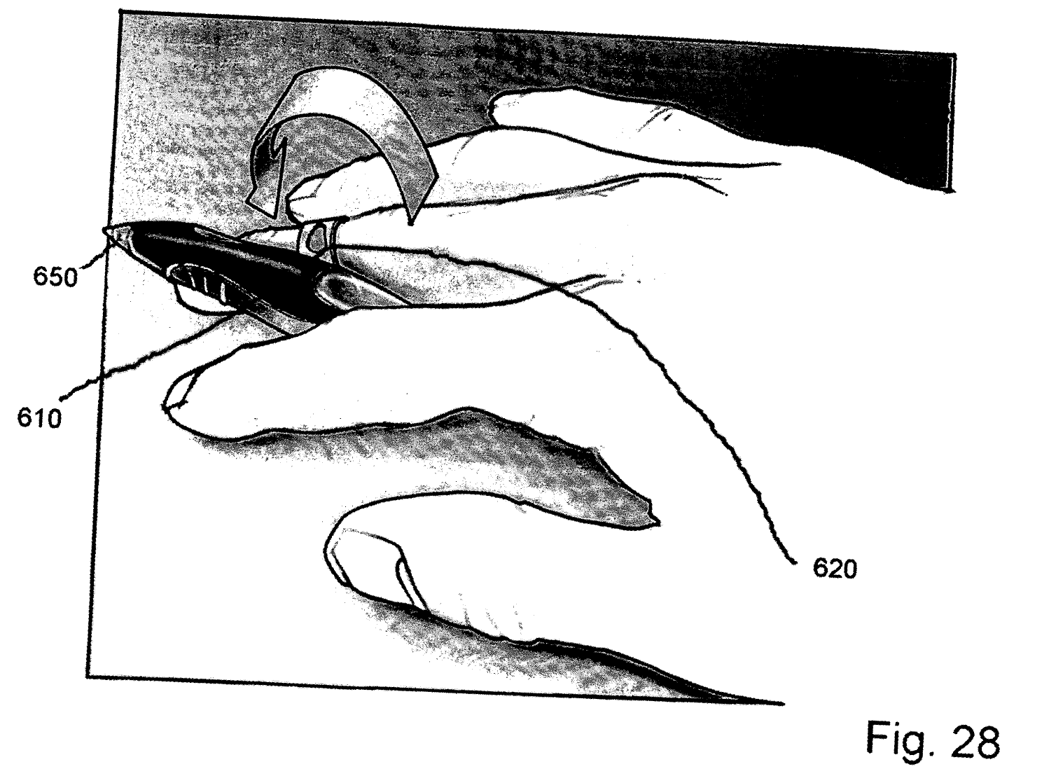

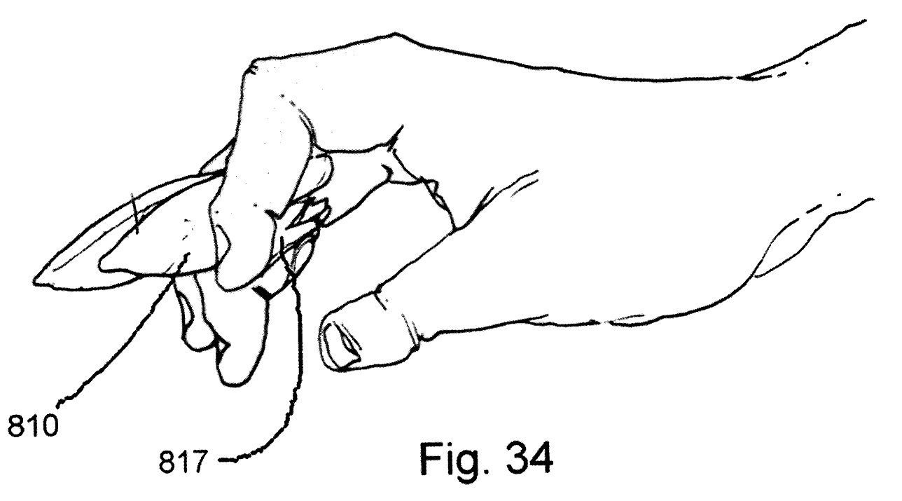

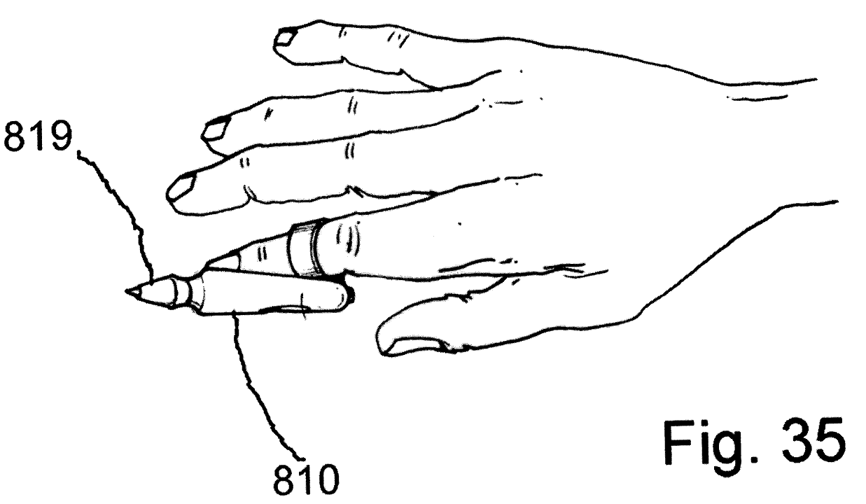

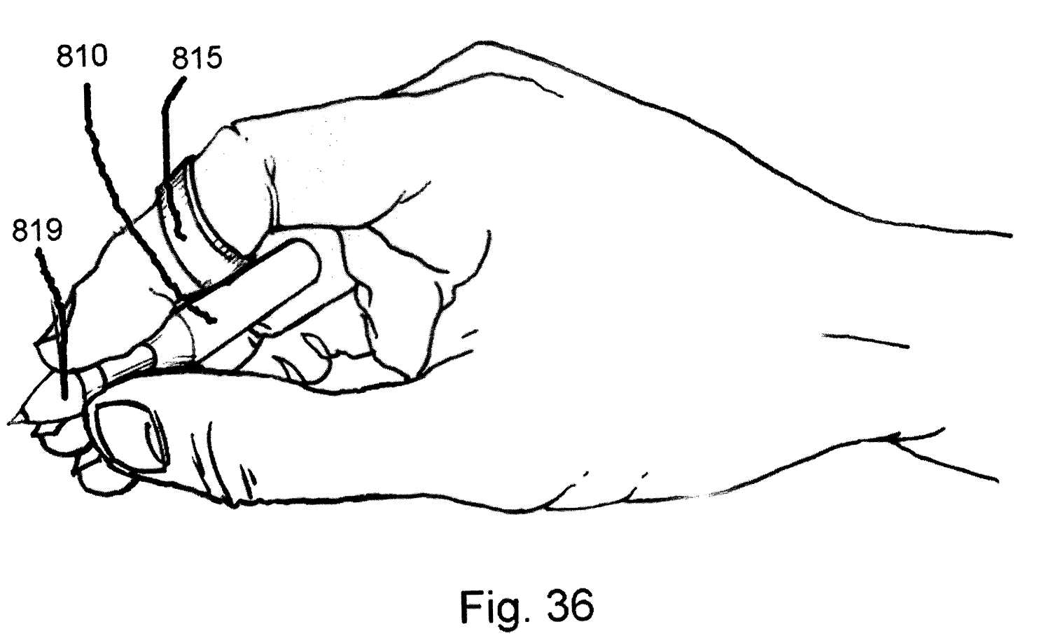

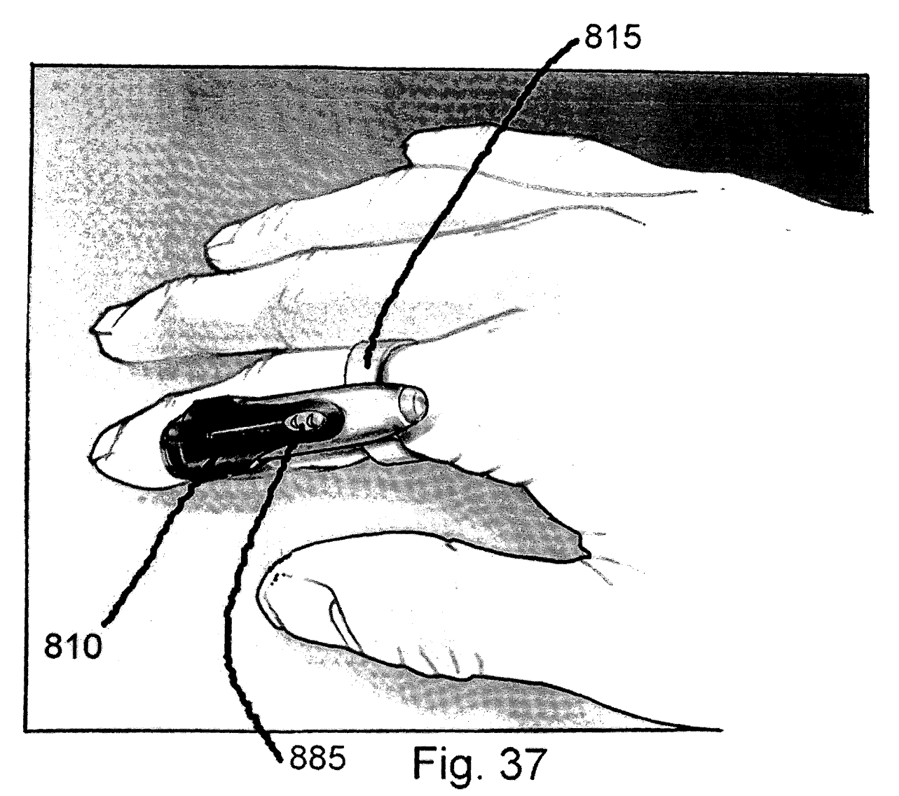

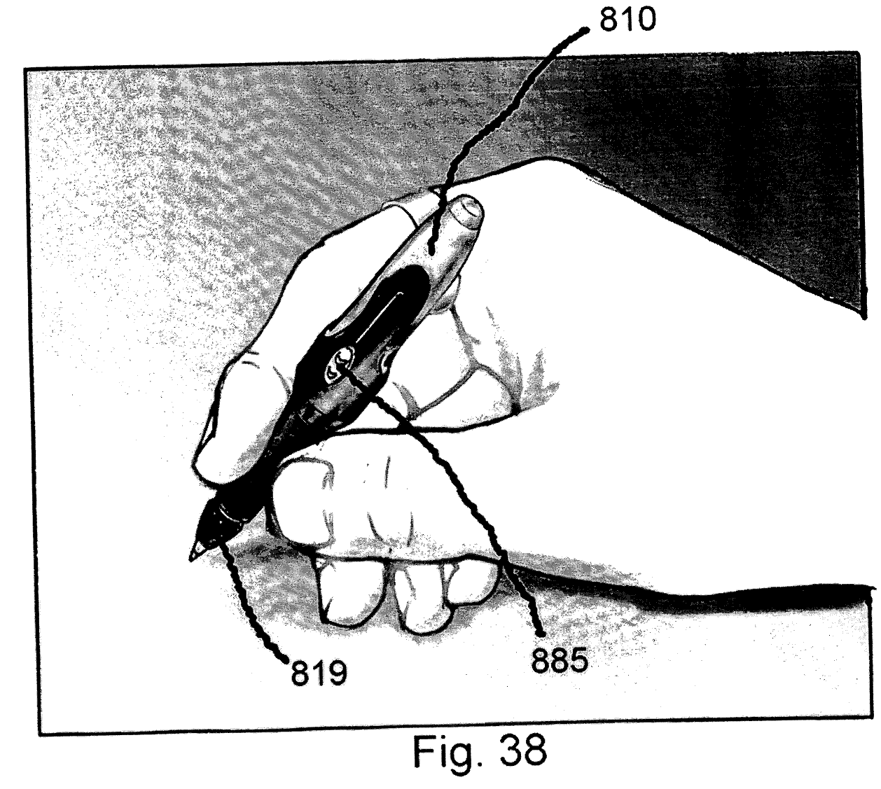

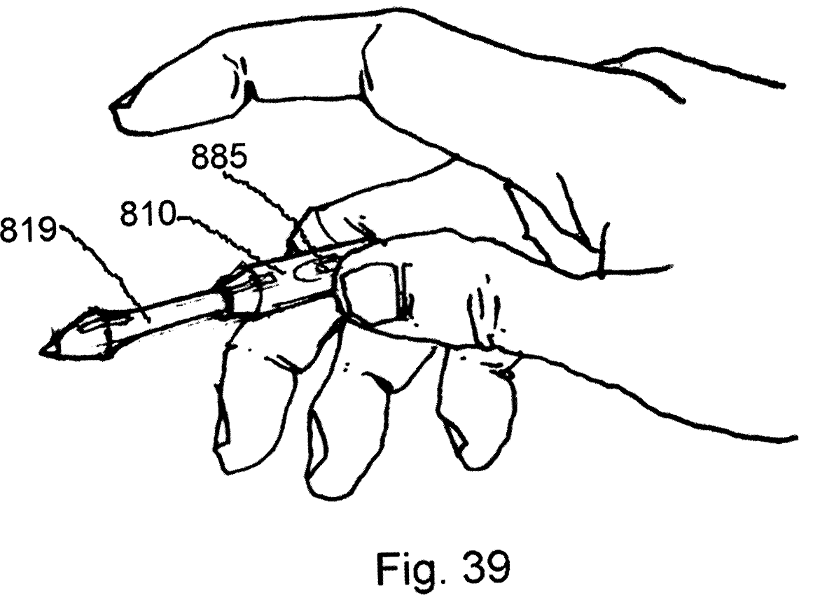

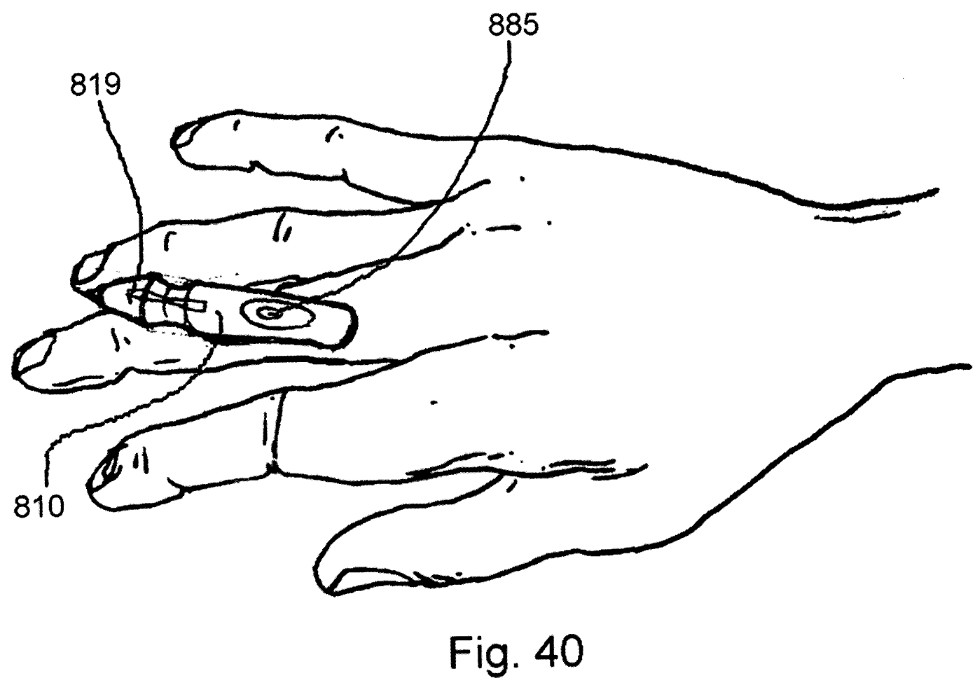

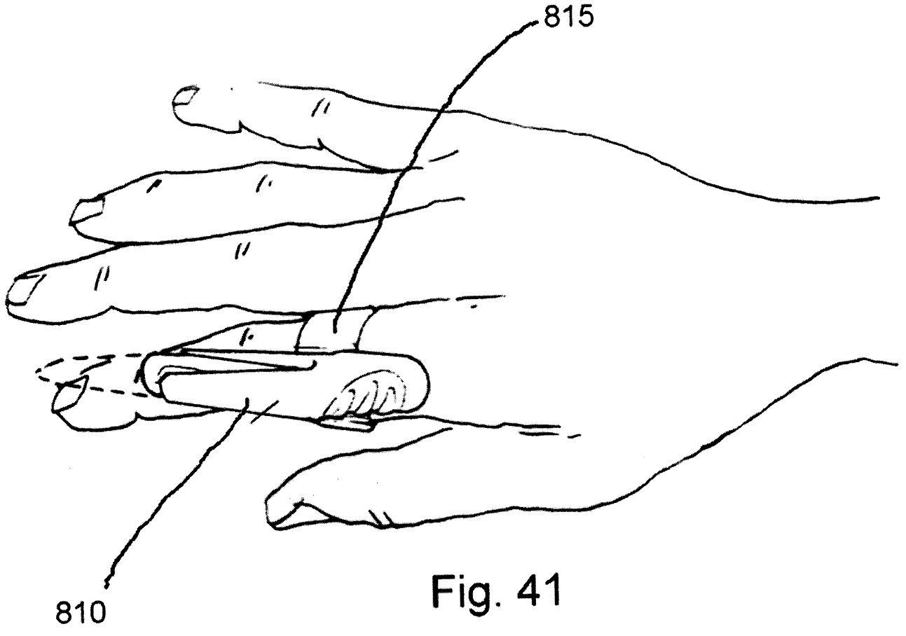

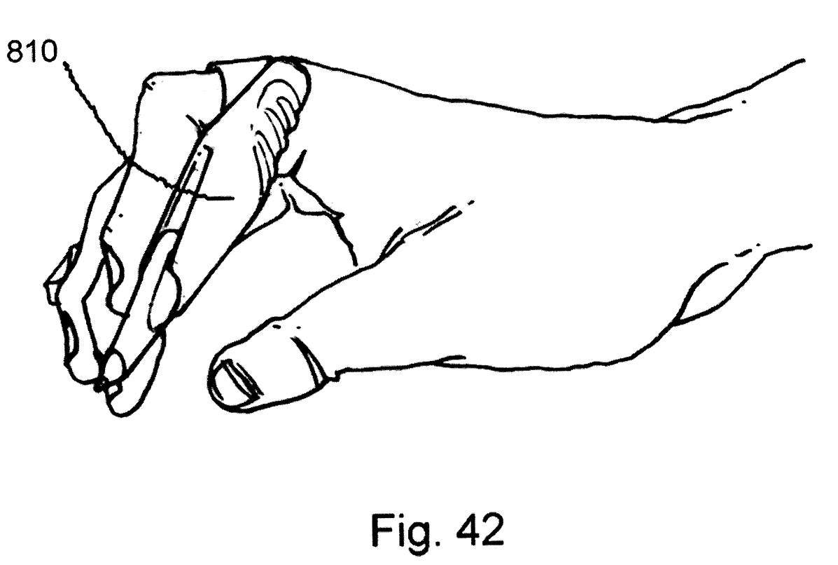

FIGS. 12-50 depict various designs for dynamic instruments in which the instrument body moves relative to the retainer in the transition from the first resting position to the second normal use position. In all these embodiments any of the five “activation” modes can be used.

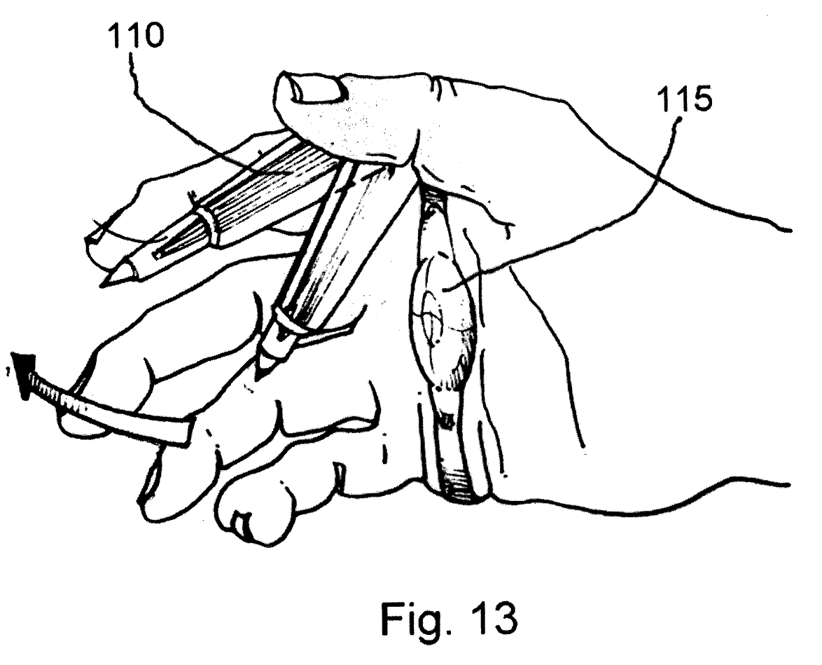

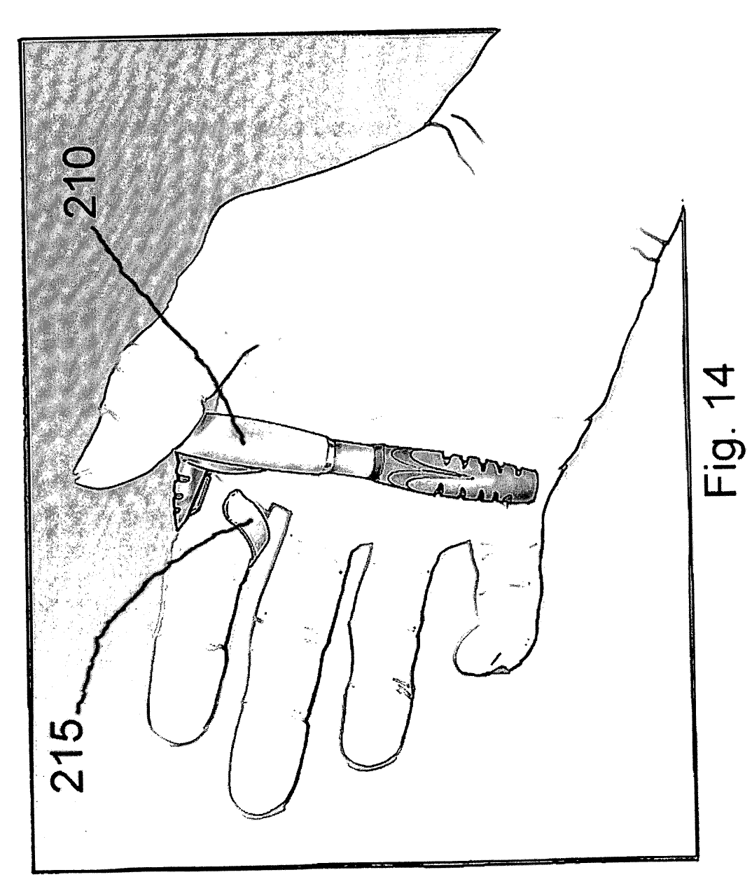

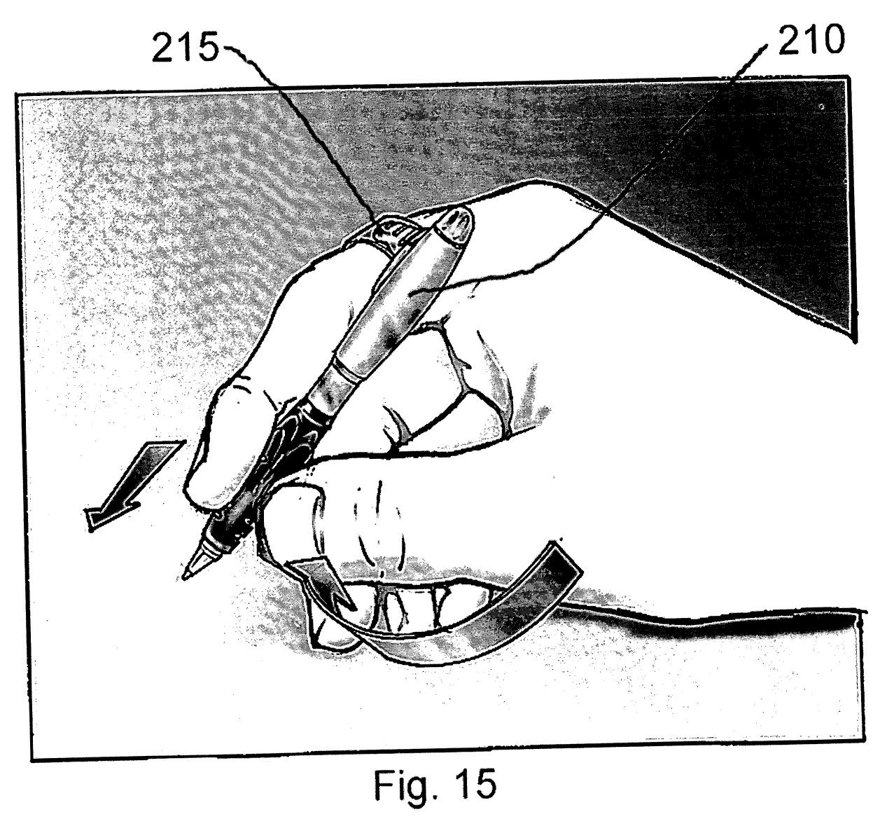

FIGS. 12 and 13 depict an embodiment that is designed with the instrument body 1 10 under the palm of the hand and generally perpendicular to the four fingers of the hand in the rest position. One of the dynamic embodiment activation modes are provided to allow the instrument body 110 to move from that first position to the second normal use position. Preferably, in this embodiment, a button or other activation means (not depicted) is provided for the user to activate for the instrument body 110 to move under the influence of a spring or other movement means. In such embodiments, the pivot is located behind the band. FIGS. 12-13 depict a version of the present invention that has as the retainer means for removably attaching the instrument to the hand a band 115 that wraps around the hand. Alternatively, as shown in FIGS. 14-15 one can use a band 215 that wraps around the index finger as the retainer means for attaching body 210. In such embodiments, the retainer is preferably located between the second and third knuckles or on the proximal phalange as shown, but can also be attached to the middle finger on the proximal phalange.

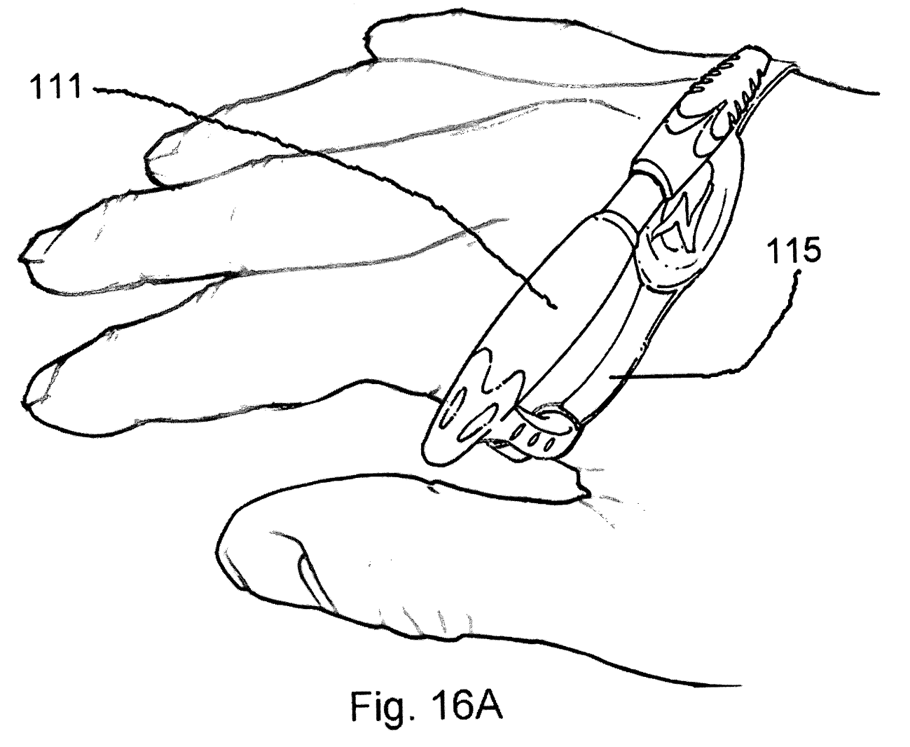

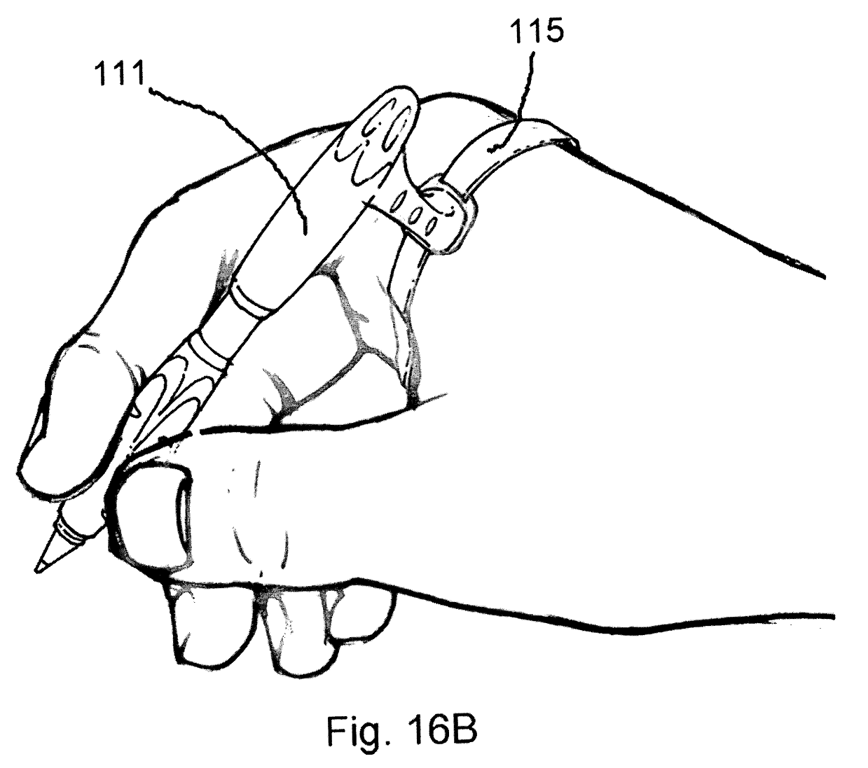

While FIGS. 12 and 13 depict an embodiment with the instrument body 110 located below the hand in both rest and use positions, another embodiment is depicted in FIG. 16A and 16B in which the instrument body 111 is across the top of the hand in the rest position instead of underneath as depicted in FIGS. 12 and 13, but the retainer 115 is still attached to either the palm of the hand. Alternatively, the retainer could be attached to the finger as described above.

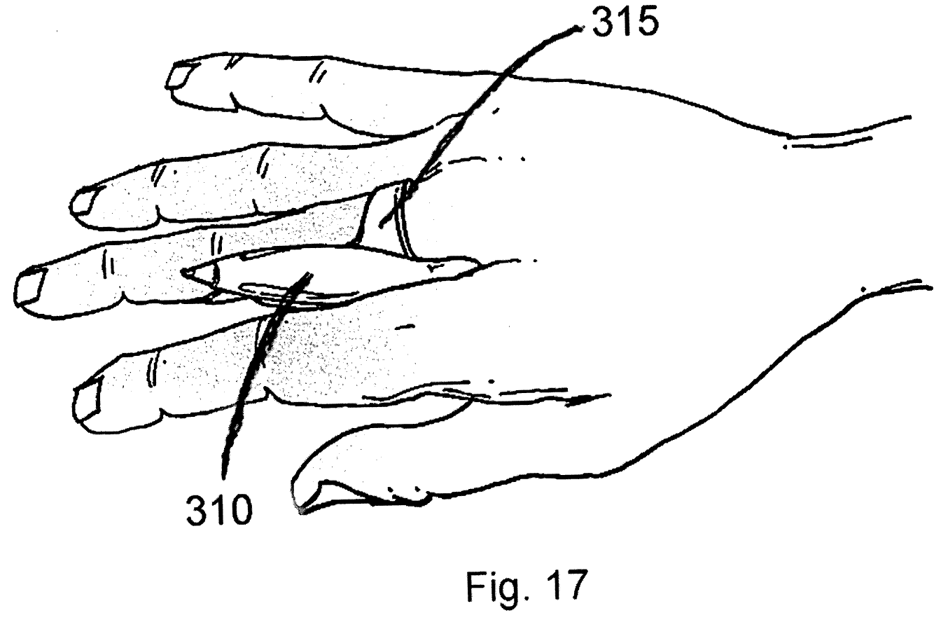

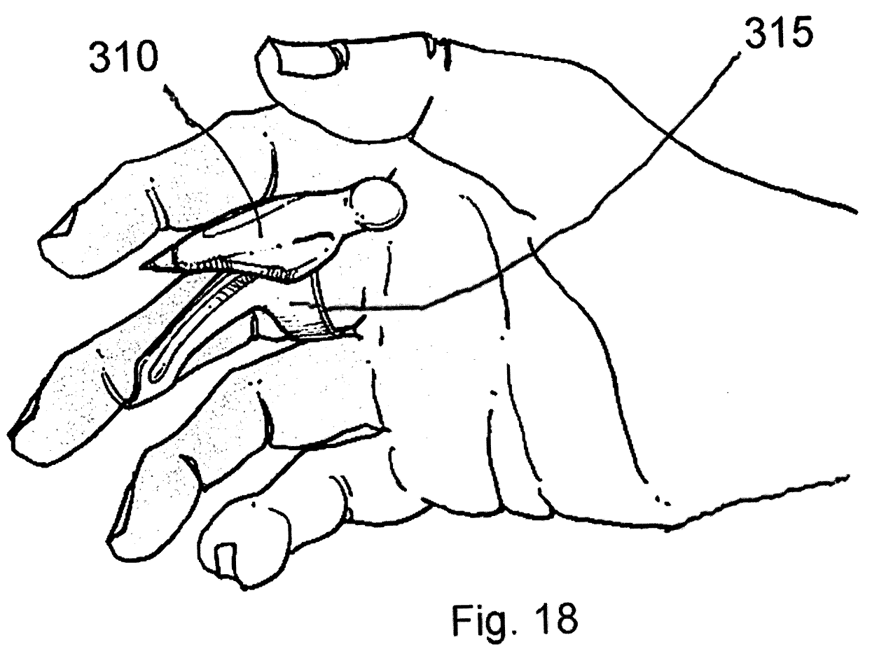

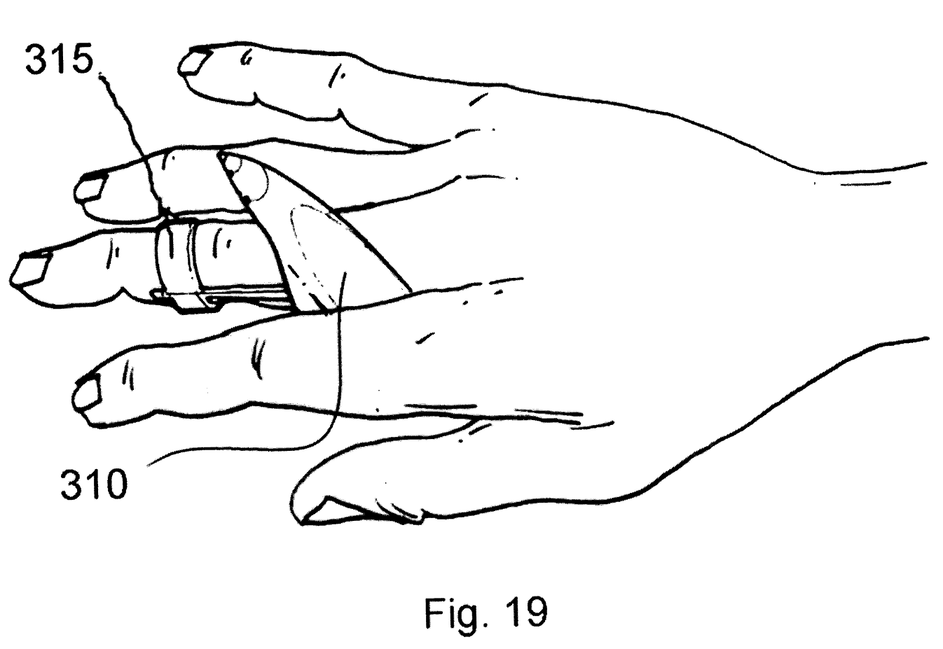

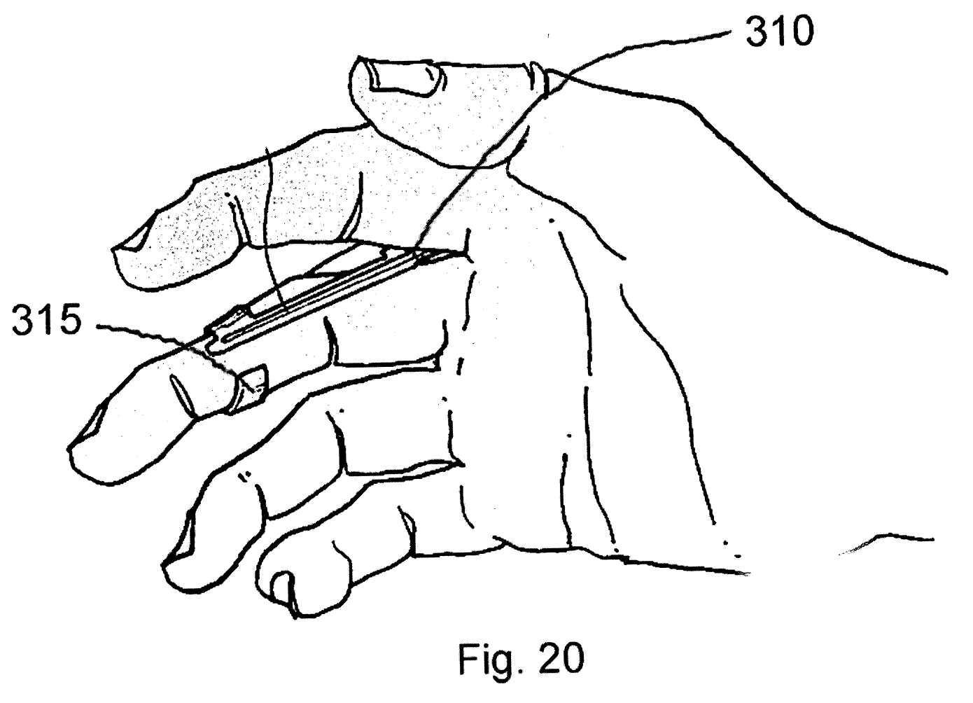

FIGS. 17-20 display yet another embodiment in which the instrument 310 is attached to the middle finger near the palm or on the proximal phalange and also on the middle finger, middle phalange by means of retainer 315. FIGS. 17 and 18 show the instrument 310 in the first, rest position showing both the front and back of the hand with the pen at rest. In this embodiment the instrument 310 slides through activation of the thumb and index finger into the natural writing position (normal use position). A further embodiment that is attached to the middle phalange of the middle finger and slides from the first rest position to the normal use position is shown in FIGS. 19 and 20. It also is preferably activated by a combination of index finger and thumb, but it could be activated by either alone as well. This embodiment could also be activated by the opposite hand. It has also been found that this writing instrument and other embodiments included in this patent could be used by handicapped persons or those with severe hand mobility issues who are unable to hold the pen in the natural writing position that was described above.

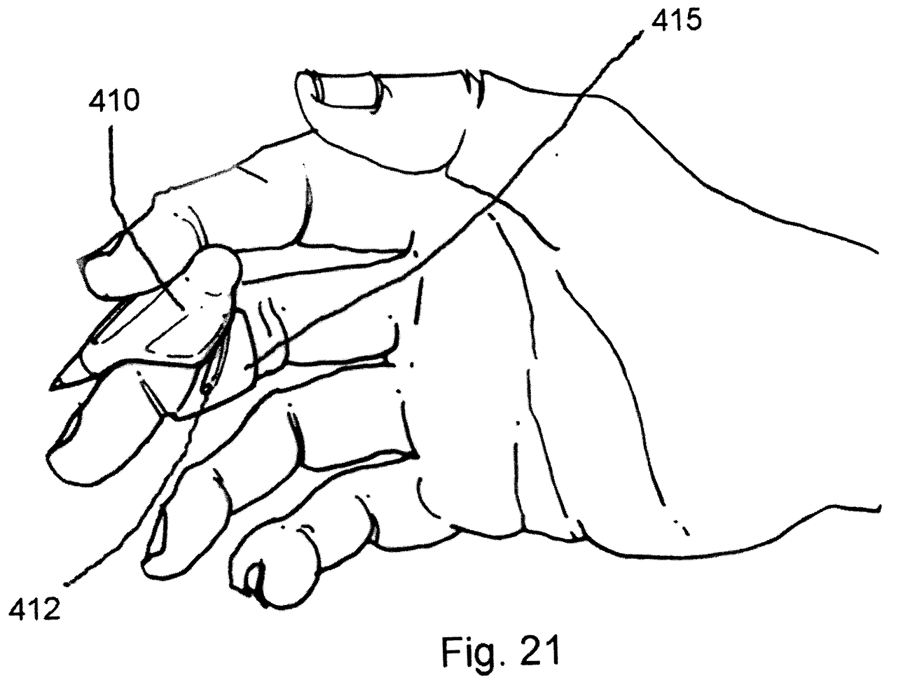

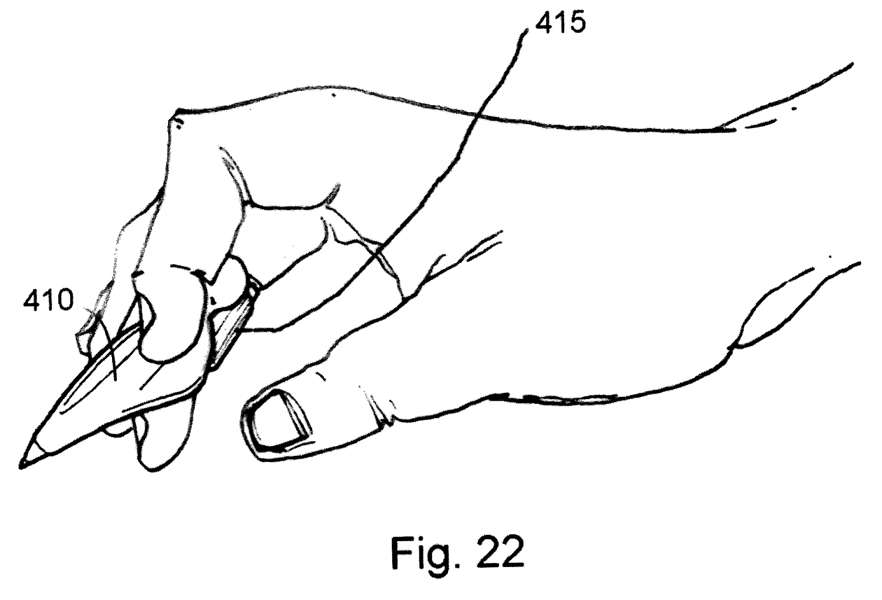

Yet another possible embodiment is depicted in FIGS. 21 and 22 which depict a side storage instrument 410 intended to be attached to the middle finger on the middle phalange with retainer 415. As seen in FIG. 21, in the rest position the instrument 410 is held along the side of the finger. The pen 410 is moved into the normal use position by activation with the index finger and the body 410 sliding along a curved slot 412.

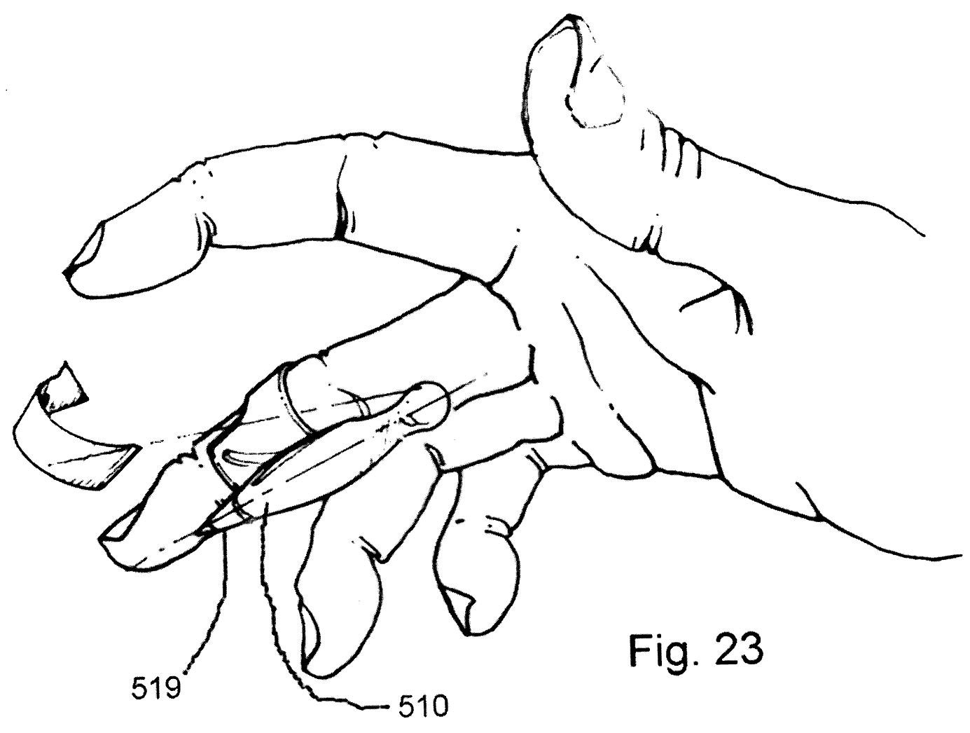

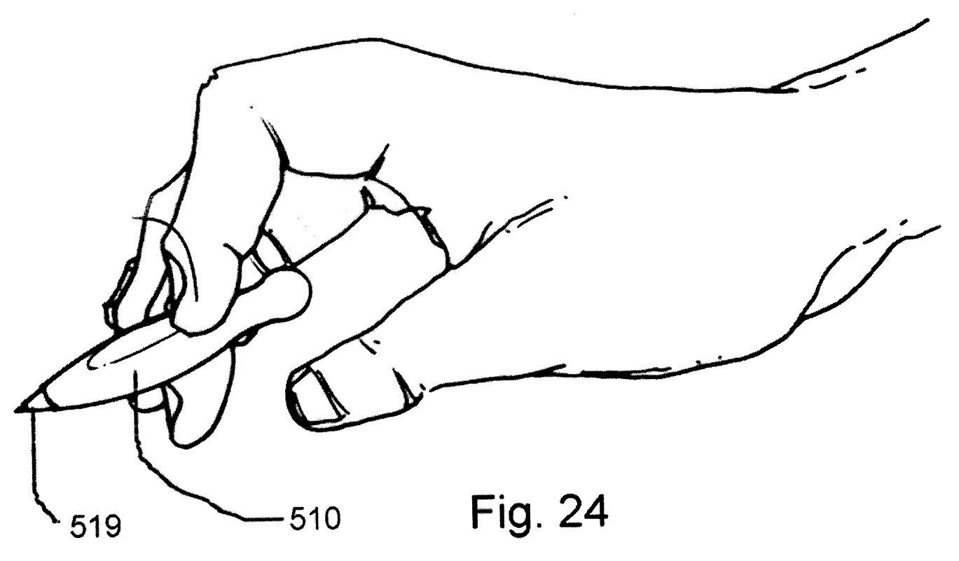

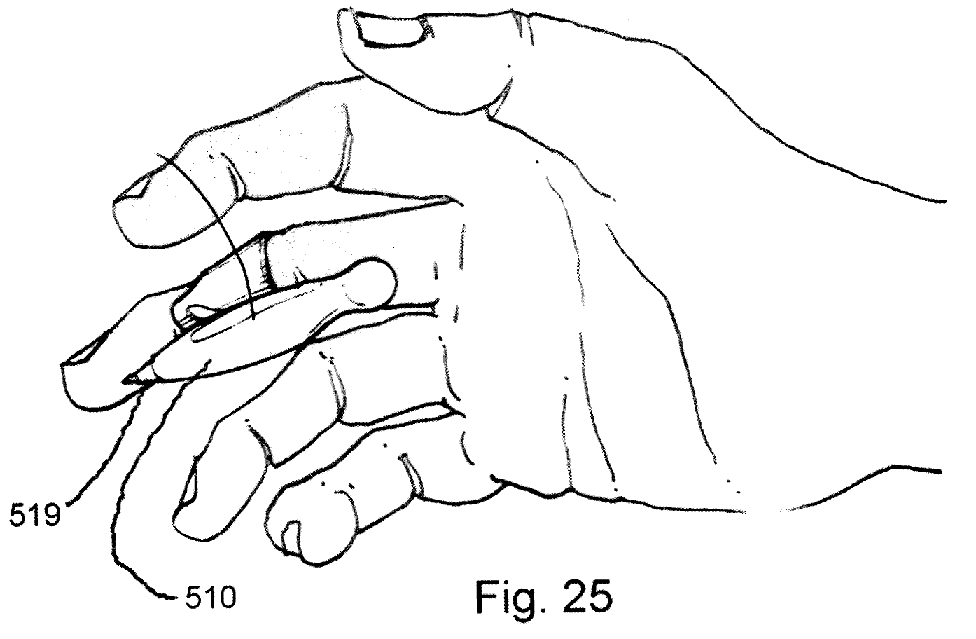

A further embodiment, with underneath storage of an instrument intended to be attached to the middle finger is shown in FIGS. 23, 24 and 25. Preferably in this embodiment the body 510 includes a utensil 519—such as the pen refill—that is retractable. FIG. 23 shows the movement of the instrument 510 when activated from the rest position under the middle finger and rotating it into the natural writing position with the index finger and the thumb, FIG. 24. FIGS. 24 and 25 show side and back views of the instrument 510.

In all of the embodiments that include movement by use of a slot the slot can either be on the retainer or attachment means or, alternatively, the slot could be part of the instrument body and a pin to engage the slot could be part of the retainer means or attachment means.

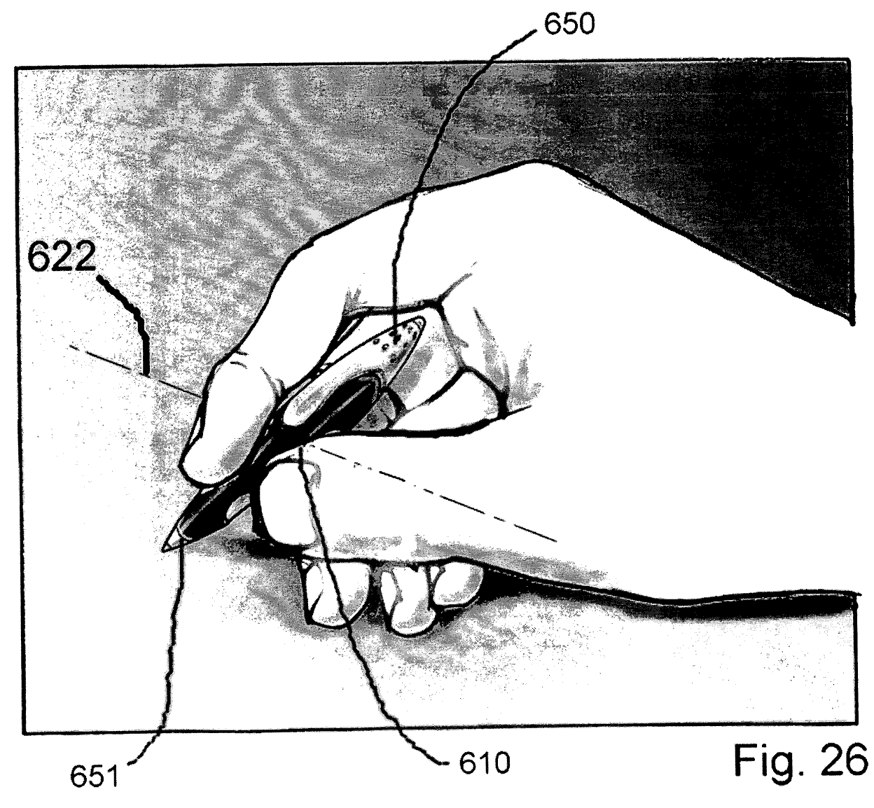

Still other embodiments are depicted in FIGS. 26-28 that show an embodiment in which the instrument 610 spins or rotates, typically by force exerted by the thumb. In this embodiment, there is a pivot point 620 on the body 610 with the ends 650 and 651 of the body 610 rotating about the pivot point 620. An axis of rotation 622 is depicted in FIG. 26. This embodiment allows for two utensils to be incorporated into a single instrument body 620 , one from each of the ends 650 and 651 of the body 610. These rotatable bodies 610 can be wound up in one direction and be button activated to allow the instrument 610 to rotate in the opposite direction to stop at various points most preferably 180 degrees from the prior position or can be made to stop in other positions to better reflect the normal use position. In embodiments such as these, the retainer is preferably adapted for the middle phalange of the middle finger. The pivot point 620 can be positioned in front of the center line of the retainer 615 or offset from that center; that is, when looking at the side of the middle finger, the pivot point is above the centerline of the middle finger. The offset can aid in having the user's fingers not prevent or inhibit the spinning motion and also aids in positioning the instrument in the natural writing position. Furthermore, automatic retraction and extending of the refill or utensil can be incorporated to enable it to move in and out as it rotates.

Alternatively, a “wobble” can be incorporated into the connection of the body to the retainer and/or attachment means attaching the instrument to the hands to more easily accommodate both the natural writing position and any individual user's actual use position. The rotatable pen design can also be spring loaded to effectuate the rotation or can be completely manual relying only upon spin force exerted by the user to transition from one use position to another.

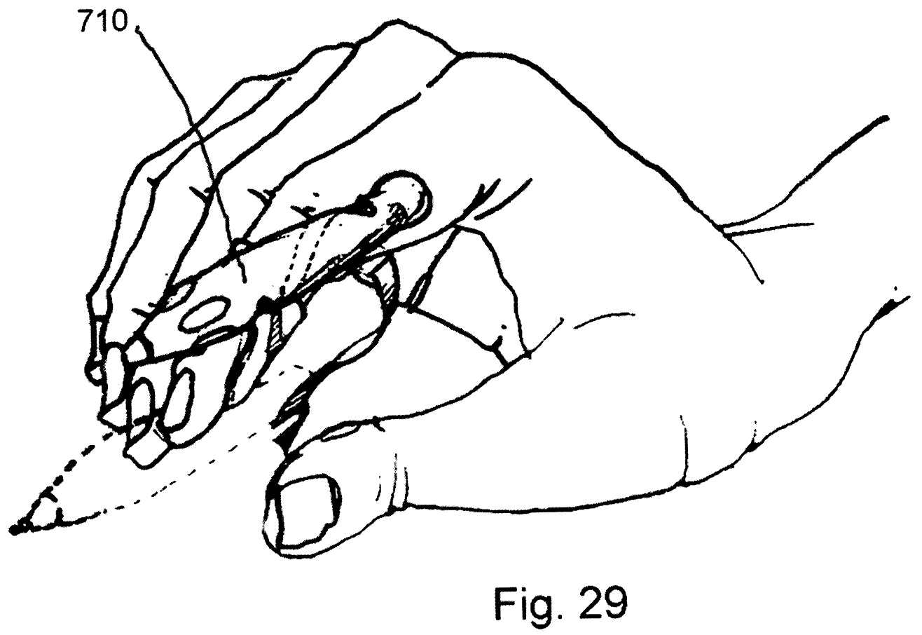

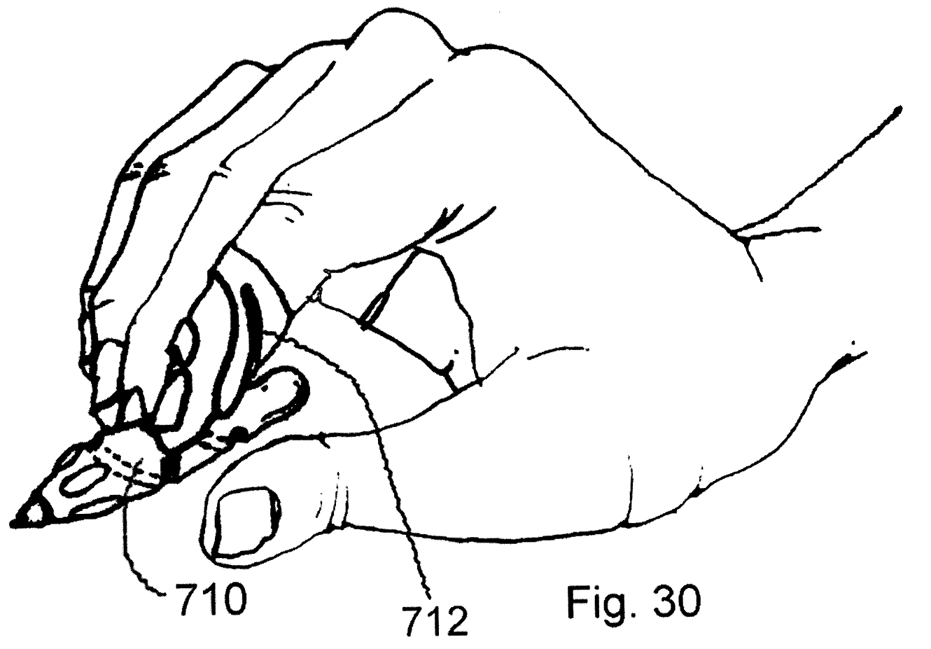

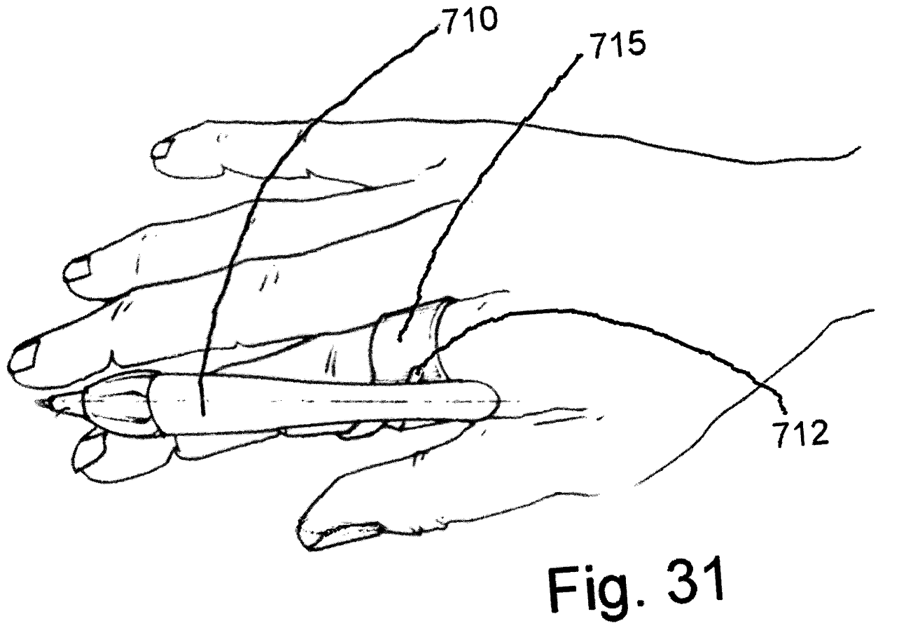

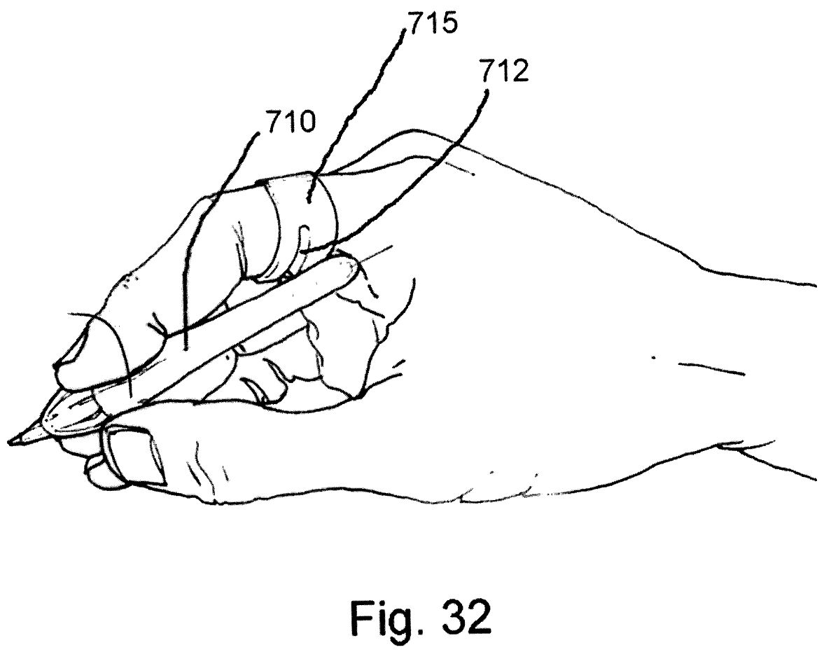

FIGS. 29-32 show additional variations in which slide pens are depicted that are particularly designed to be affixed to the index fingers. FIG. 29 shows a slide pen 710 for the index finger preferably to be attached between the first and second knuckles or middle phalange. Comparing FIG. 29 with FIG. 30, one can see the movement of the instrument 710 from the rest position depicted in FIG. 29 to the normal use position depicted in FIG. 30. In the slide pen embodiments, the retainer means and/or attachment means includes a groove or guide 712 to help slide the instrument 710 into natural writing position. The instrument 710 snaps back into the rest position when not in use because of a spring loaded mechanism (not depicted). The thumb pulls the pen into place in the natural writing position. Another version of the slide pen—meant to be used on the index finger between the second and third knuckles or proximal phalange is seen in FIGS. 31 and 32 and it is operated in the same way as the writing instruments in FIGS. 29 and 30. An optional feature of these pens is that the refill or utensil will extend as the pen moves from first to second position as shown in FIG. 29 and 30.

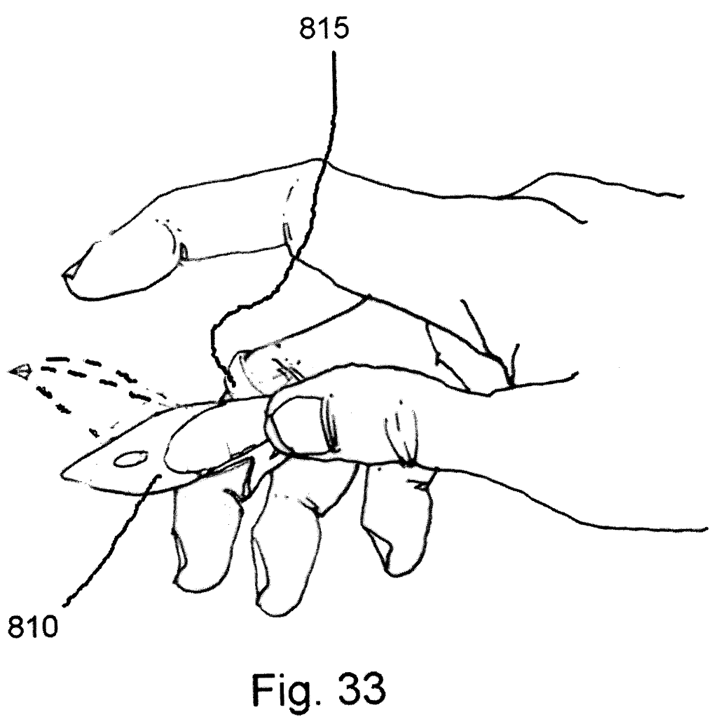

The embodiments of FIGS. 33-42 are similar to a “switch blade knife”. Two different types are contemplated, although both are button activated. One extends out of the end of the pen, when a button is pressed, the other rotates out of the body when a button is pressed. They could be attached to either the middle or proximal phalange of the index or middle finger.

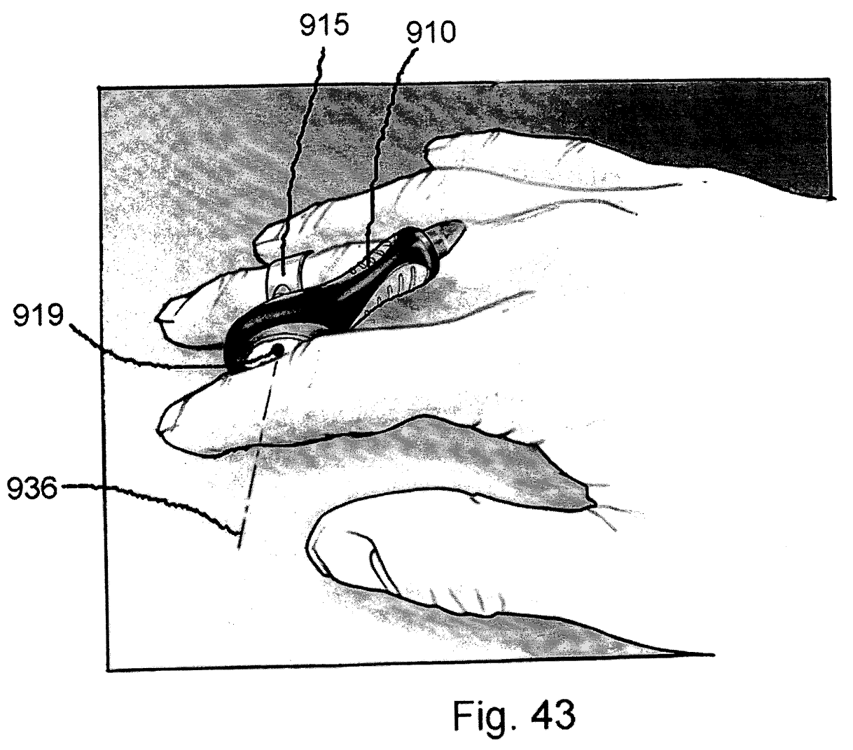

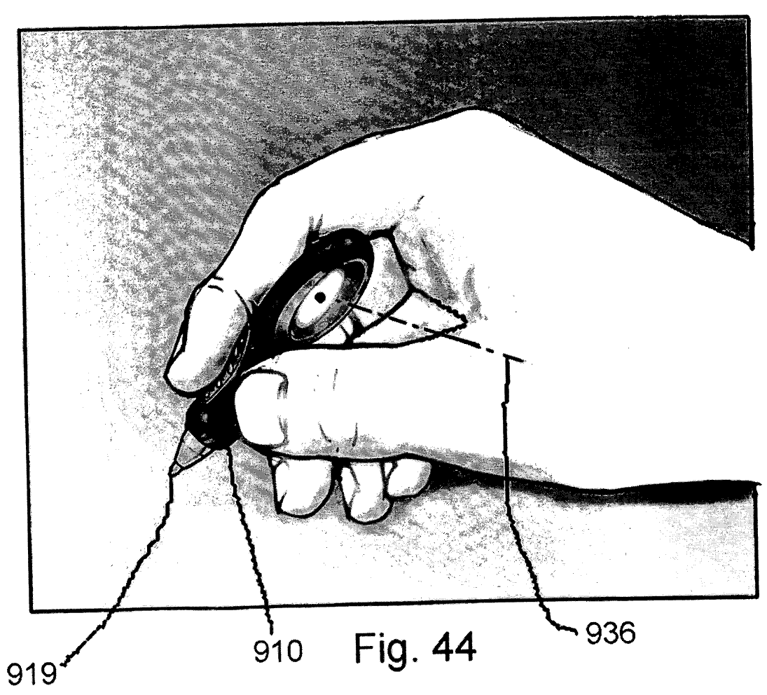

The instrument of FIGS. 43 and 44 works by having body 910 pivoting about pivot point 919 on axis 936 on the middle phalange of the middle finger. It may include a spring-loaded mechanism (not depicted) to push body 910 back into the resting position automatically after use. Preferably, the index finger activates the movement of the pen. The utensil 919, in this case a pen refill, also extends as it is moved into the natural writing position.

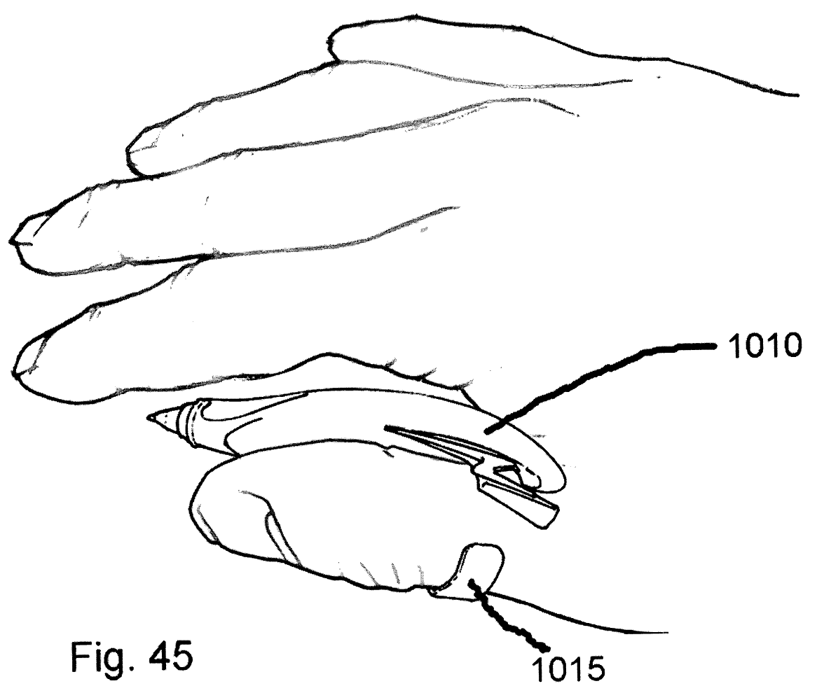

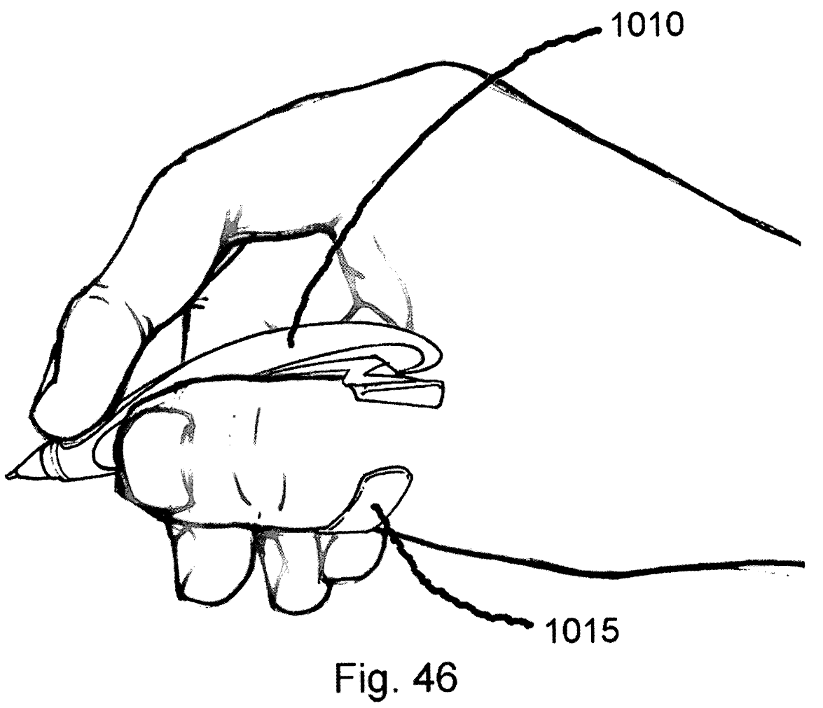

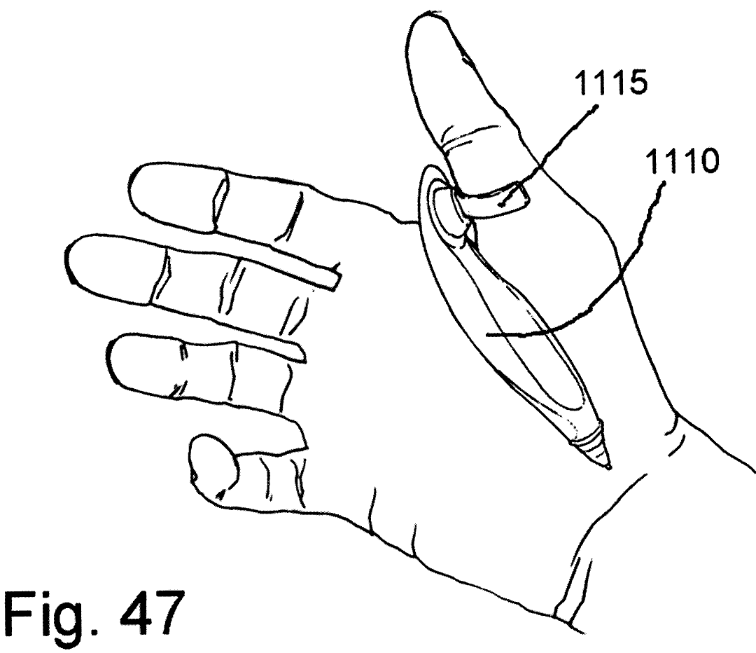

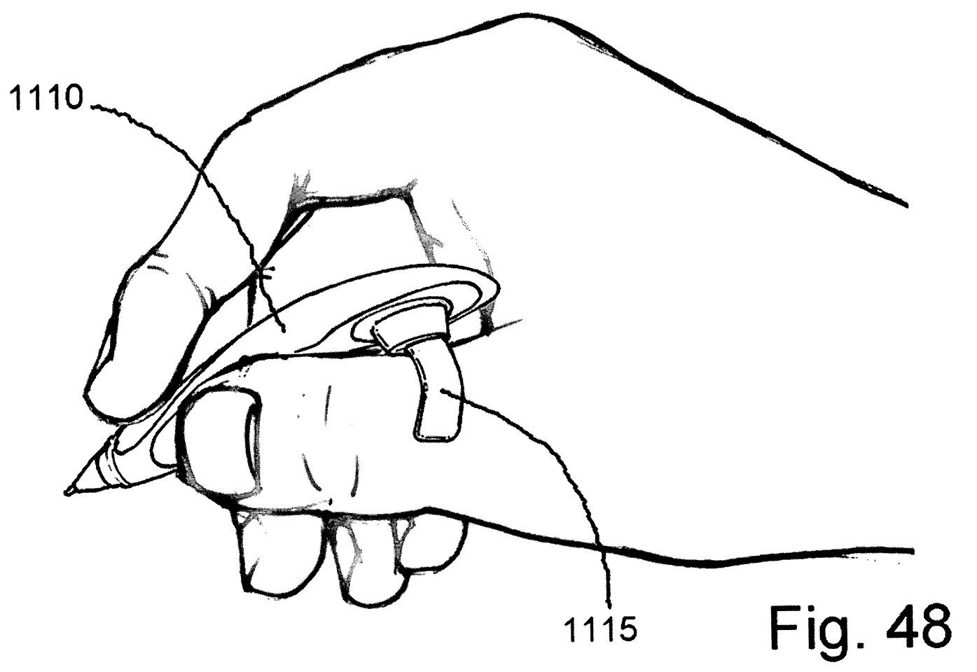

The embodiments of FIGS. 45-48 show instruments that are attached to the thumb. FIGS. 45 and 46 show the first and second use positions of the static version of the thumb pen with body 1010 and retainer 1015 and uses the first “activation’ mode. FIGS. 47 and 48 show a dynamic thumb pen with a body 1110 and a retainer 1115. This dynamic pen is preferably operated using the second, third, fourth, or fifth “activation” modes. While FIG. 47 depict the rest position as under the hand, one skilled in the art will recognize that in this embodiment the rest position can also be on top of the hand with the instrument body resting on web between the users thumb and index finger. In this alternate embodiment it is preferred to provide the instrument with button activation.

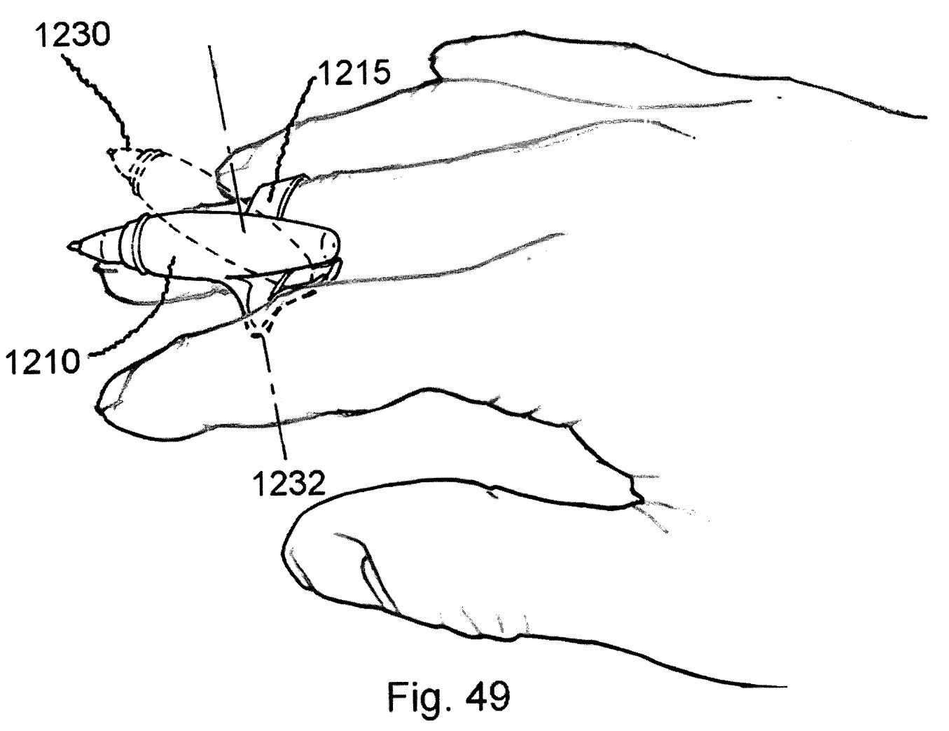

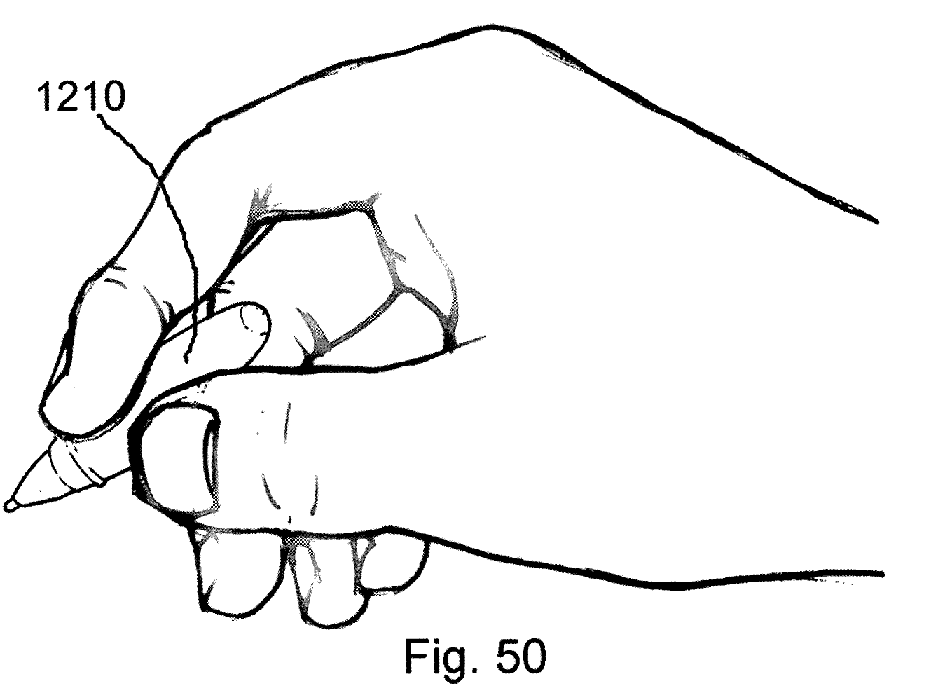

FIGS. 49 and 50 depict another embodiment that is similar to the embodiment of FIG. 2, but is hinged to allow flexibility regarding both the natural writing position and the actual writing position. As can be seen, this embodiment again includes body 1210 and retainer 1215. In this embodiment there is a hinge point 1232 that allows the body 1210 to also move to hinged position 1230 indicated by dashed lines. The activation modes used in this embodiment would preferably be either the second, third, or fourth mode.

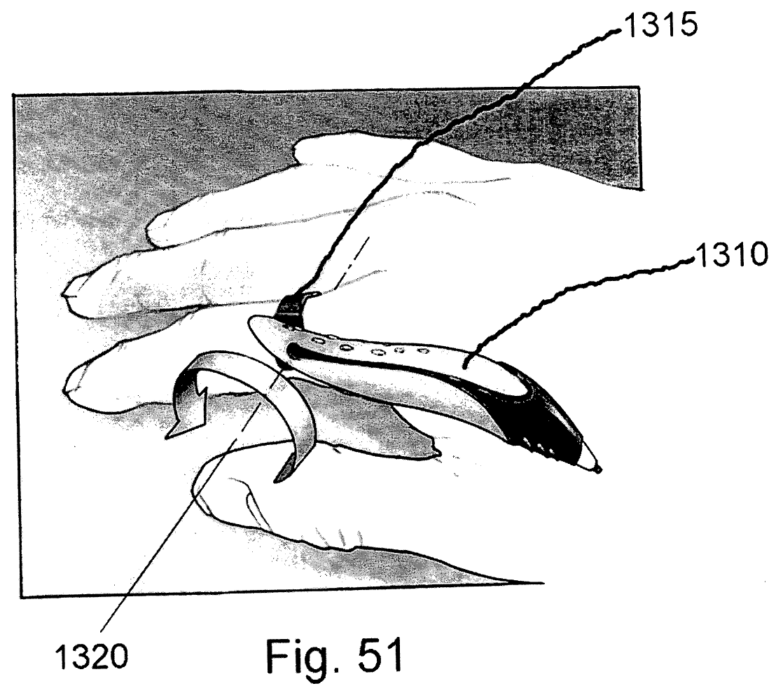

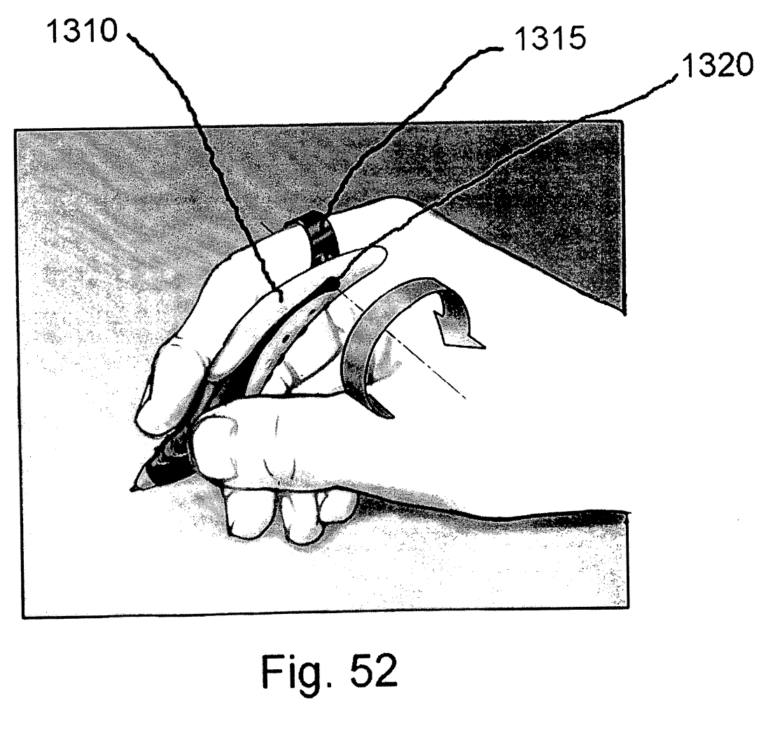

FIGS. 51-52 depict a further embodiment adapted for the index finger. In this embodiment, as is the case with instruments of this invention, the retainer 1315 can be seen along with instrument body 1310. A pivot point 1320 is provided. Preferably in this embodiment, the user activates the transition from one position to another with a flick of the user's wrist.

As will be appreciated by those skilled in the art the embodiments discussed herein are merely illustrative and many of the concepts can be combined or alternated if desired and still remain within the scope of the present invention.

1. A normally handheld instrument adapted to be removably affixed to the hand of a user, comprising:
an instrument body;
a utensil connected to the body;
a retainer attached to the instrument body;
wherein the retainer is adapted to allow it to be removably affixed to a part of the user's hand in such a way that, when so affixed, the attached instrument body is positionable in at least two positions: a first resting position and a second normal use position.

2. A normally handheld instrument comprising:
body means for providing a utensil;
retainer means for removably attaching the instrument to a part of a hand of a user,
attachment means for attaching the retainer means to the body means;
said retainer means and attachment means together allowing the body means, when the retainer means is removably affixed to a part of the user's hand, to be positionable into at least two positions: a first resting position and a second normal use position.

3. An instrument adapted to be removably affixed to the finger of a user, comprising:
a body;
a utensil connected to the body;
a retainer attached to the body, the retainer being adapted to fit one of the user's fingers chosen from the group consisting of the index finger, middle finger and thumb;
wherein, when the retainer is attached to the finger, the body of the instrument is positionable in at least a first resting position and a second normal use position.

4. An instrument adapted to be removably affixed to the finger of a user, comprising:
body means for providing a utensil,
retainer means for affixing the instrument to one of the user's fingers chosen from the group consisting of the index finger, the middle finger, and the thumb,
attaching means for attaching the body means to the retainer means
wherein the retainer means and attachment means together allow the body means to be positioned in a resting position and, by simple movement of the user's fingers, hand, or arm is available for use in a normal use position.

5. The instrument of claims 1-4 wherein the instrument body is short.

6. The instrument of claim 5 wherein the instrument body is less than 2 inches.

7. The instrument of claims 1-4 wherein the retainer is resiliently adjustable and shapeable.

8. The instrument of claims 1-4 wherein the instrument may be worn on the either hand.

9. The instrument of claims 1-4 wherein the instrument is static.

10. The instrument of claims 1-4 wherein the instrument is dynamic.

11. The instrument of claims 1-4 wherein the attachment of the retainer to the body is accomplished by a substantially Z-shaped attachment adapter.
